(19) United States
(12) Patent Application Publication
(10) Pub. No.: US 2019/0012625 A1
(43) Pub. Date: Jan. 10, 2019

(54) AUTONOMOUS VEHICLE/DRIVE-THROUGH SYNCHRONIZATION SYSTEM AND SYNCHRONIZATION METHOD

(71) Applicant: PANASONIC INTELLECTUAL PROPERTY MANAGEMENT CO., LTD., Osaka (JP)

(72) Inventors: Matthew John LAWRENSON, Lausanne (CH); Julian Charles NOLAN, Lausanne (CH); Norihiko KOBAYASHI, Tokyo (JP); Nobuhiro FUKUDA, Kanagawa (JP); Keiji NISHIHARA, Kanagawa (JP)

(73) Assignee: PANASONIC INTELLECTUAL PROPERTY MANAGEMENT CO., LT D., Osaka (JP)

(21) Appl. No.: 16/022,004

(22) Filed: Jun. 28, 2018

Related U.S. Application Data
(60) Provisional application No. 62/528,715, filed on Jul. 5, 2017.

(51) Int. Cl. G06Q 10/06; G06Q 30/06; G06Q 50/12; G07C 5/00; G05D 1/00

(52) U.S. Cl. CPC G06Q 10/06311; G06Q 30/0635; G05D 2201/0213; G07C 5/008; G05D 1/0088; G06Q 50/12

(57) ABSTRACT

A synchronization system for synchronizing operations of an autonomous vehicle (AV) and a restaurant system of a restaurant is provided. The AV transmits to the restaurant system, order data of an order placed via the AV and estimated time of arrival (ETA) by the AV. The restaurant system, generates a food preparation/delivery (FPD) process for execution by at least one resource of the restaurant, and generates at least one scheduled instruction to the at least one resource of the restaurant for executing the at least one FPD process. The restaurant system further determines, based on progress status of the at least one FPD process being executed, an estimated order completion time for the order. The synchronization system controls the AV and the restaurant system to minimize a difference between the ETA and the estimated order completion time.

### CROSS-REFERENCE TO RELATED APPLICATION(S)

The present application claims the benefit of U.S. Provisional Patent Application No. 62/528,715 filed on Jul. 5, 2017. The entire disclosure of the above-identified application, including the specifications, drawings and/or claims, is incorporated herein by reference in its entirety.

### BACKGROUND

### 1. Field of the Disclosure

The present disclosure relates to an autonomous vehicle/drive-through restaurant synchronization system. More particularly, the present disclosure relates to autonomous vehicles that are operated to place an order to a restaurant having a drive-through prior to arriving at the restaurant, and retrieve the food at the estimated arrival time to reduce delay at the drive-through.

### 2. Background Information

A. Autonomous Vehicles

An autonomous vehicle (AV) is a vehicle capable of sensing its location, details of its surrounding environment and navigating along a route without needing a human driver.

By allowing a computer to take control of the vehicle's operation a finer level of control may be achieved compared to when a human is driving. This becomes especially true as more and more vehicles become autonomous as communication between the vehicles increases. Consider a vehicle driving to a destination, by allowing a computer to control the vehicles motion many small adjustments can be made to the route and vehicle speed that mean it can arrive at the location at an exact time. A condition that may detract an autonomous vehicle arriving at an exact time is the actions of other vehicles on the road. For example, if a vehicle slows down in front of the AV and it is dangerous to pass then it is inevitable that the following AV will be slowed. However, as more and more vehicles are becoming autonomous and also have potential ability to communicate with each other, such scenarios may be less likely to occur. Further, when such scenarios do arise, the issue may be resolved through communication between the autonomous vehicles.

For some purposes, the time variability due to a human driving the vehicle may be negligible. However, for some scenarios, it can lead to a loss of efficiency. For example, in a queue where a person in a vehicle is waiting for an output of a certain process, if a vehicle in front must wait for a process to finish, then it can slow all of the vehicles following behind.

B. Drive-Through Restaurant Operation-1

Competition in the restaurant market has increased. At the same time, a general trend is taking place that personalization is demanded, which has led to restaurants offering more personalized choices. While personalization may better satisfy consumer demand, it also has the effect of making the food preparation process more complicated and lengthy, and thus in turn affects an amount of time a customer needs to wait in a drive-through queue.

Hence a dilemma exists in managing restaurant operations. The restaurant operators would wish to give increased levels of personalization and customer choice, yet shorten the time each customer is required to wait until reception of food ordered.

C. Drive-Through Restaurant Operation-2

As with many areas of life, food preparation is becoming increasingly automated, with jobs that were previously fulfilled by human employees may be performed by robots and algorithms.

This can be seen in food preparation, with examples being McDonalds researching robot operated restaurants, café s being operated by coffee-making robots and various machines for making particular types of food, for example sushi and pizza.

Further, there is a general trend toward increased algorithmic optimization of processes, for example by using machine learning to improve a variety of manufacturing processes.

US2016/0232625A, which relates to event planning, discloses a technique for increasing the convenience of a user by making recommendations as to time, a place, etc. at the time of event planning using additional information obtained by sensors etc. in addition to information relating to various tastes of the user. An example of a recommendation is information indicating the location of an event place to which an autonomous vehicle is to bring the user to meet another person.

It is foreseen that, in future societies in which autonomous vehicles will be common, the need for a driver to effectively utilize time he or she will spend inside an autonomous vehicle will increase. Examples as to the manner of spending time inside an autonomous vehicle are things relating to taking of a meal. For example, assume that the driver of an autonomous vehicle wants to stop by a restaurant (e.g., drive-through) while driving toward a destination. In this case, it is necessary for the driver to change the destination temporarily to the location of the restaurant, and after stopping by the restaurant, change a route again to go to the final destination from the restaurant. However, in US2016/0232625A, no consideration is given to the case that the driver of an autonomous vehicle changes the destination temporarily to the location of, for example, a drive-through of a restaurant to pick up food, and then changes a route so as to reach the final destination. No consideration is given either to how to allow the driver to effectively utilize time he or she spends inside an autonomous vehicle during an autonomous drive.

### SUMMARY

The present disclosure has been made in the above circumstances, and an object of the disclosure is therefore to provide a drive-through restaurant synchronization system for synchronizing operation(s) of an autonomous vehicle and a synchronization method that make it possible to, when a user, such as a driver, wants to use a drive-through of a restaurant during an autonomous drive, change a route to a destination adaptively so that it includes the drive-through of the restaurant in response to a simple operation of the user and increase the convenience in an appropriate manner by allowing the user to effectively utilize time he or she spends during an autonomous drive.

The present disclosure provides a synchronization system for synchronizing operations of an autonomous vehicle (AV) and a restaurant system of a restaurant, wherein the AV receives, by a user interface of the AV, an order submitted to the restaurant system; obtains initial vehicle data of the AV based on a location of the restaurant, the initial vehicle data including an estimated time of arrival (ETA) at the restaurant; and transmits, to the restaurant system, order data of the order and the initial vehicle data; the restaurant system extracts, from a memory of the restaurant system, at least one food preparation/delivery (FPD) template corresponding to the order data; generates, using a processor of the restaurant system, at least one FPD process for execution by at least one resource of the restaurant based on the order data and the extracted at least one FPD template; generates at least one scheduled instruction to the at least one resource of the restaurant for executing the at least one FPD process by the restaurant system; and determines, based on a progress status of the at least one FPD process being executed, an estimated order completion time for the order; and the synchronization system controls the AV and the restaurant system to minimize a difference between the ETA and the estimated order completion time.

The present disclosure also provides a synchronization method for synchronizing operations of an autonomous vehicle (AV) and a restaurant system of a restaurant, comprising the steps of the AV's receiving, by a user interface of the AV, an order submitted to the restaurant system; obtaining initial vehicle data of the AV based on a location of the restaurant, the initial vehicle data including estimated time of arrival (ETA) at the restaurant; and transmitting, to the restaurant system, order data of the order and the initial vehicle data; the restaurant system's extracting, from a memory of the restaurant system, at least one food preparation/delivery (FPD) template corresponding to the order data; generating, using a processor of the restaurant system, at least one FPD process for execution by at least one resource of the restaurant based on the order data and the extracted at least one FPD template; generating at least one scheduled instruction to the at least one resource of the restaurant for executing the at least one FPD process by the restaurant system; and determining, based on a progress status of the at least one FPD process being executed, an estimated order completion time for the order; and the synchronization system's controlling the AV and the restaurant system to minimize a difference between the ETA and the estimated order completion time.

The present disclosure further provides a non-transitory computer readable storage medium that is stored with a computer program that, when run by a processor, causes a computer to execute a process comprising the steps of receiving, by a user interface of the AV, an order submitted to a restaurant system of a restaurant; obtaining initial vehicle data of the AV based on a location of the restaurant, the initial vehicle data including estimated time of arrival (ETA) at the restaurant; transmitting, to the restaurant system, order data of the order and the initial vehicle data; extracting, from a memory of the restaurant system, at least one food preparation/delivery (FPD) template corresponding to the order data; generating, using a processor of the restaurant system, at least one FPD process for execution by at least one resource of the restaurant based on the order data and the extracted at least one FPD template; generating at least one scheduled instruction to the at least one resource of the restaurant for executing the at least one FPD process by the restaurant system; determining, based on a progress status of the at least one FPD process being executed, an estimated order completion time for the order; and controlling the AV and the restaurant system to minimize a difference between the ETA and the estimated order completion time.

Furthermore, the present disclosure provides a computer for preparing an order received from an autonomous vehicle (AV), comprising a memory that stores instructions; and a processor that executes the instructions, wherein when executed by the processor, the instructions cause the processor to execute a process comprising the steps of receiving, from the AV, order data of an order submitted to a restaurant system of a restaurant; receiving initial vehicle data of the AV, the initial vehicle data being based on a location of the restaurant and including an estimated time of arrival (ETA) of the AV at the restaurant; extracting at least one food preparation/delivery (FPD) template corresponding to the order data; generating at least one FPD process for execution by at least one resource of the restaurant based on the order data and the extracted at least one FPD template; generating at least one scheduled instruction to the at least one resource of the restaurant for executing the at least one FPD process; determining an estimated order completion time for the order based on a progress status of the at least one FPD process being executed; and controlling the AV and the restaurant system to minimize a difference between the ETA and the estimated order completion time.

The present disclosure makes it possible to change a route to a destination adaptively so that it includes a drive-through of a restaurant (or coffee shop, grocery store, and etc.) in response to a simple operation of a user and increase the convenience in an appropriate manner by allowing the user to effectively utilize time he or she spends during an autonomous drive.

### BRIEF DESCRIPTION OF THE DRAWINGS

FIG. 1 shows an exemplary general computer system that is configured to place and fulfil a remote order placed in an autonomous vehicle, according to an aspect of the present disclosure;

FIG. 2 shows an exemplary autonomous vehicle system, according to one aspect of the present disclosure;

FIG. 3 shows exemplary restaurant system, according to the one aspect of the present disclosure;

FIG. 4 shows an exemplary data flow between an autonomous vehicle system and a restaurant system, according to the one aspect of the present disclosure;

FIGS. 5A-5C show an exemplary process flow between an autonomous vehicle and a restaurant system for fulfilling an order, according to the one aspect of the present disclosure;

FIGS. 6A-6D show exemplary displays of an autonomous vehicle user interface for placing an order, according to the one aspect of the present disclosure;

FIG. 7 is a block diagram showing an exemplary configuration of a demand adjustment system that is centered by a vehicle including an autonomous drive control device, according to another aspect of the present disclosure;

FIG. 8 is a first part of a flowchart of an example control procedure, for an autonomous drive of the vehicle, of the autonomous drive control device according to the other aspect of the present disclosure;

FIG. 9 is a second part of the flowchart of the example control procedure, for an autonomous drive of the vehicle, of the autonomous drive control device according to the other aspect of the present disclosure;

FIG. 10 is a flowchart showing an example operation procedure of a guide route merging process executed in the vehicle according to the other aspect of the present disclosure;

FIG. 11 is a diagram illustrating example transitions in a global route that occur during an autonomous drive of the vehicle according to the other aspect of the present disclosure;

FIG. 12 is a block diagram showing an example configuration of the demand adjustment system that is centered by a demand adjustment server according to the other aspect of the present disclosure;

FIG. 13 shows an example structure of user data that are registered in a user database;

FIG. 14 shows an example structure of restaurant data that are registered in a restaurant database;

FIG. 15 is a sequence diagram showing part of an example operation procedure of demand adjustment performed by the demand adjustment system according to the other aspect of the present disclosure; and

FIG. 16 is a sequence diagram showing the remaining part of the example operation procedure of the demand adjustment performed by the demand adjustment system according to the other aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

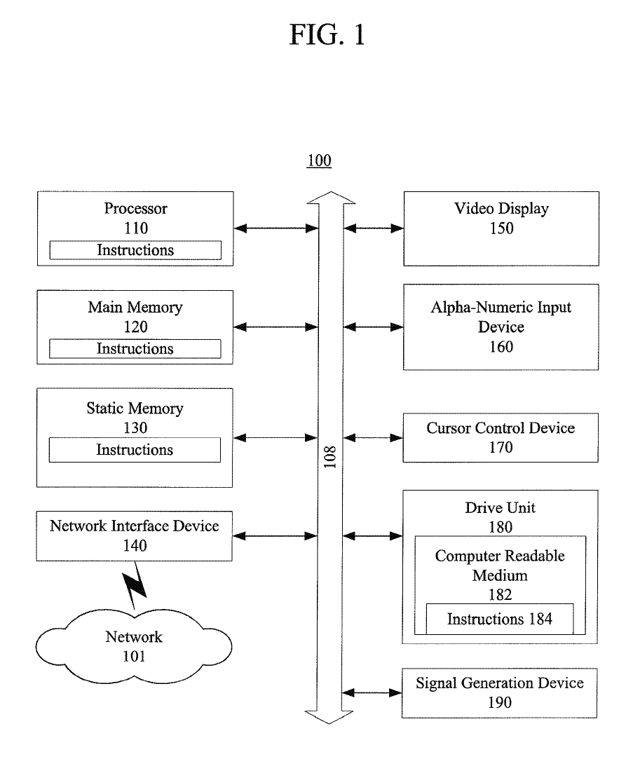

FIG. 1 shows an exemplary general computer system that is configured to place and fulfil a remote order placed in an autonomous vehicle, according to one aspect of the present disclosure.

A computer system 100 can include a set of instructions that can be executed to cause the computer system 100 to perform any one or more of the methods or computer-based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a communications device, a control system, a web appliance, a network router, switch or bridge, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In the particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In the particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limiting embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

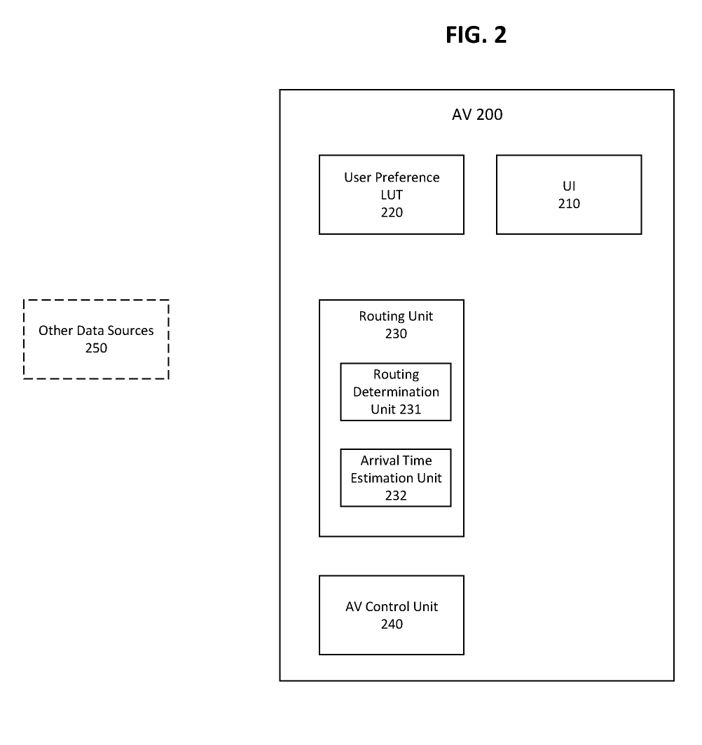

FIG. 2 shows an exemplary autonomous vehicle system, according to the one aspect of the present disclosure.

An autonomous vehicle (AV) may be a vehicle that may have a particular level of autonomous control that allows the AV to modify its arrival time at a target destination. An AV may be configured to have differing levels of autonomy. For example, an AV may have levels of autonomy, ranging from level-1 autonomy (e.g., low level) to level-5 autonomy (e.g., self-driving vehicles).

As illustrated in FIG. 2, an AV 200 includes a user preference look-up-table (LUT) 220, a user interface (UI) 210, a routing unit 230, and an AV control unit 240. Each of these units may be implemented as an integrated circuit, and may be controlled by a processor. Further, one or more of the above noted units may be included in a computer.

The UI 210 may be used to place a food order with a target restaurant. In an example, the UI 210 may include, without limitation, a touchscreen on which menu choices may be displayed for selection. Further, the UI 210 may include a voice-driven interface, such as Alexa® or Siri®, whereby the UI may ask questions or give a list of items a user may select from. The UI 210 may be connected to a communication circuit for transmitting order data corresponding to the food order placed via the UI 210.

In addition to the items ordered, the order data may additionally include information on how the user would like the food to be prepared. For example, user may specify a particular temperature for a steak order, such as well-done or rare. Such information may be stored as a preference, such that it may be transmitted automatically upon placing of an order or may be manually specified during the placing of the order. Further, payment information may be pre-stored, such that the payment may be also transmitted with the order data for quicker delivery of the food order.

The user preference LUT 220 may be stored in a memory. The user preference LUT 220 may store a set of user preferences. For example, stored user preferences may include, without limitation, (i) a tolerance in delivery times (e.g., maximum wait time at drive-through) specified by a user, (ii) routes or types of routes that the user prefers or dislikes, (iii) maximum/minimum speeds tolerated by the user, (iv) toll road preferences, and the like.

The routing unit 230 includes a routing determination unit 231 and an arrival time estimation unit 232. The routing determination unit 231 may include and/or execute a routing determination algorithm, and the arrival time estimate unit 232 may include and/or execute an arrival time estimation algorithm. The routing determination unit 231 may generate or create a route for the AV's journey or destination. The arrival estimation unit 232 may be able to estimate the AV's arrival time (ETA) at the terminal point of the route. In an example, the terminal point of the route may be an entrance of the restaurant or a specific order pick up location (e.g., a specific order pickup window or area).

According to the one aspect of the present disclosure, one or both of the routing determination unit 231 and the arrival estimation unit 232 may use external data sources, such as other data sources 250, which may be one or more database servers that provide additional information for determining the best route or more accurately judge the estimated time of arrival of the AV at a selected restaurant.

The other data sources 250 includes, without limitation, databases containing traffic data, data sources that are able to estimate a number of autonomous vehicles compared to human-driven vehicles on the determined route to the selected restaurant, and databases storing current and predicted meteorological data. Further, the other data sources 250 may be one or more external databases that may connected to the AV 200 via a network.

Vehicle data includes, without limitation, data that describes routing information relevant to the selected restaurant, and estimated time of arrival at the selected restaurant. Examples of vehicle data may include, without limitation, (i) direction of the AV will take towards the selected restaurant, (ii) end destination of the route (e.g., at an entrance to a parking lot of the selected restaurant), (iii) AV's ETA, and (iv) potential delays to the ETA. The potential delays to the ETA may be based on, without limitation, an estimation based on historic data (i.e., data stored in other data sources 250), and an estimation based on a number of human-driven vehicles compared to autonomous vehicles along the route. In an example, vehicles type information (e.g., human-driven vehicles, autonomous vehicles, etc.) may be drawn from the other data sources 250.

The AV control unit 240 controls the motion of the AV. For example, the motion of the AV may include, without limitation, steering, acceleration, vehicle breaking, changing of lanes, and the like.

First communication of the vehicle data to the selected restaurant may be referred to as initial vehicle data, with subsequent updates of the vehicle data being referred to as current or updated vehicle data.

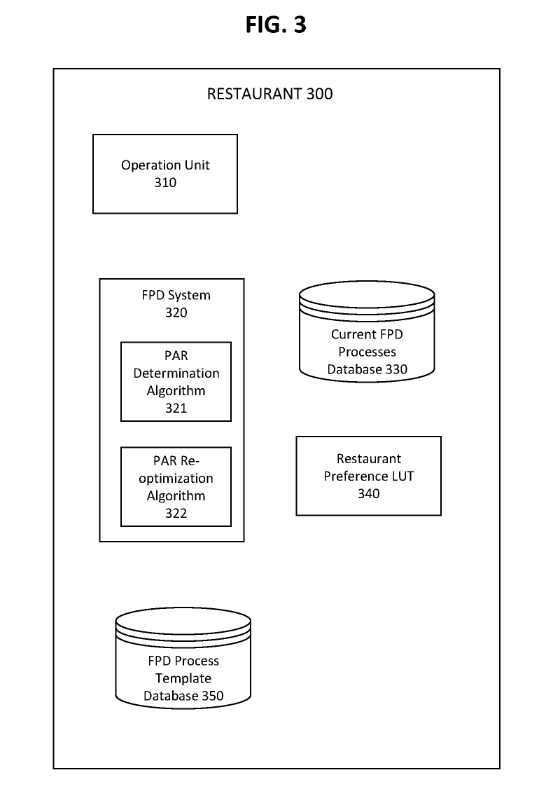

FIG. 3 shows exemplary restaurant system, according to the one aspect of the present disclosure.

A restaurant system 300 includes an operation unit 310, a food preparation/delivery (FPD) system 320, a current FPD processes database 330, a restaurant preference lookup table (LUT) 340, and FPD process template database 350. Each of these units may be implemented as an integrated circuit, and may be controlled by a processor. Further, one or more of the above noted units may be included in a computer.

The operation unit 310 may control one or more operations or resources of the restaurant system 300. The restaurant system 300 may be used for various manners of control of a restaurant that may be selected by an autonomous vehicle (AV). The restaurant may include a drive-through facility, at which the AV may receive an order placed while the AV is in operation. The operation unit 310 may include a plurality of resource units, which may include, without limitation, food preparation robots, robots interacting with customers, systems that track locations of food items, systems that check quality of the food items, and human employees working in the restaurant.

The FPD system 320 includes a process and route (PAR) determination algorithm 321, and a PAR re-optimization algorithm 322. One or more of the PAR determination algorithm 321 and the PAR re-optimization algorithm 322 may be executed by a processor. The PAR determination algorithm 321 may instruct the processor to receive, from an AV, initial vehicle data, and a set of customizable FDP templates (e.g., cheese burger template, chees fries template, milk shake template, and etc.). The PAR determination algorithm 321 may instruct the processor to determine an optimal combination of FPD processes with which to prepare an order transmitted by the AV, and a route for the AV to follow in order to arrive at a designated handover or receipt location (e.g., facility specific route) at a specified time. In an example, a FPD process may be generated based on an extracted FPD template, with customization requested by a customer (e.g., no onion).

In an example, a route towards the designated handover or receipt location of the restaurant may be generated by an AV's route determination unit included in the AV based on time and location specified by the restaurant system 300.

Alternatively, an exact route towards the designated handover or receipt location of the restaurant (e.g., route to an entrance of the restaurant) may be a combination of (i) a facility specific route created by an AV's route determination algorithm, and (ii) a route created by the PAR determination algorithm. In an example, the facility specific route created by the PAR determination algorithm may be a route to be used once the AV has arrived at a restaurant (i.e., from the pickup window of the drive-through facility towards a designated exit of the restaurant). In an example, the facility specific route may be transmitted to the AV upon arrival at the restaurant or may be transmitted prior to arrival.

The PAR re-optimization algorithm 322 may instruct the processor to carry out the same task(s) as the PAR determination algorithm 321, but uses current vehicle data (i.e., updated vehicle data) that is supplied after the order is initially transmitted by the AV, and a combination of the FDP processes and operation status data, such as progress status of FPD processes. More specifically, the current vehicle data may be used, rather than the initial vehicle data that was supplied with order data of the order initially transmitted by the AV. The operation status data may be data that informs the restaurant system as what has been completed and/or amount (e.g., percentage) of completion within the FPD processes.

The PAR determination algorithm 321 and the PAR re-optimization algorithm 322 may be able to create a request for the AV to change its route, speed or the like. Such a request may be a route modification request. The route modification request may be for a partial route or a full route. Further, the route modification request may include information that allows the AV's routing unit to create a route.

The FPD process template database 350 stores a set of process definitions that pertain to either preparation of a meal or delivering of the meal. For example, definitions pertaining to preparation of a meal may include, without limitation, ingredients, program(s) to be executed by the operation unit 310 or resources controlled by the operation unit 310, and the like. More specifically, the meal may be prepared by human employees or by food preparation robots. Further, definitions pertaining to delivering of the food may specify, without limitation, which drive-through window the order is to be received, and/or process that needs to be followed during the handover of the order.

In an example, the processes pertaining to the preparation of the meal and/or the delivery of the meal may have various parameters. The parameters may include information as to acceptable delays that are allowed to be included in the process. For example, the acceptable delays may include delays where the process can be stopped without deteriorating the quality of the food being prepared. The parameters may also include tolerances in cooking times.

The current FPD processes database 330 may store data relating to FPD processes being executed and a current status of food preparation within the selected restaurant. Further, the current FPD processes database 330 may store data relating to a current workload and future workload of the operation unit 310. Based on the stored FPD processes and workload of various resources of the restaurant, an estimated time of completion for a food order may be determined. The initial estimation may be adjusted in view of fluctuations in the workload of various resources of the restaurant controlled by the operation unit 310. Further, in view of the estimated time of completion and the initial vehicle data, a food order may be queued to begin preparation at a particular time, rather than beginning food preparation in accordance with order received. Accordingly, a more freshly prepared food may be provided when the AV arrives at the restaurant to receive the food order.

The restaurant preference LUT 340 may store a set of restaurant preferences, which may concern topics describing desired operation of the restaurant. Examples of restaurant preferences may include, without limitation, a number of staff available to work in different areas of the restaurant, and relative priority of various tasks to be performed in the restaurant.

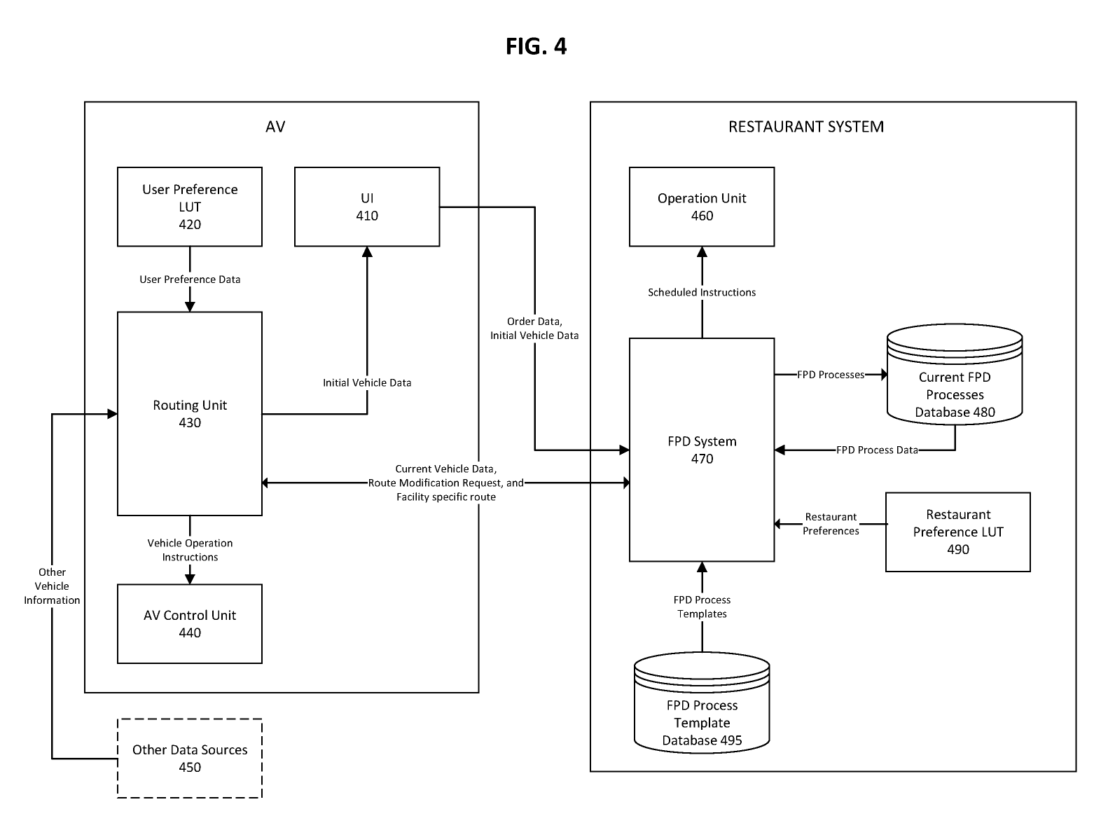

FIG. 4 shows an exemplary data flow between an AV system and a restaurant system, according to the one aspect of the present disclosure.

An autonomous vehicle (AV) may include a user interface (UI) 410, a user preference lookup table (LUT) 420, a routing unit 430, and an AV control unit 440. The routing unit 430 may include a routing determination algorithm for determining a route in view of provided information (e.g., toll road preferences, local road/expressway preferences, traffic condition, a number of vehicles present on potential routes, types of vehicles present on potential routes and the like), and/or an arrival time estimation algorithm for providing an estimated time of arrival in view of the determined route and other relevant information (e.g., traffic condition, weather condition, accident report, and the like), which may be executed by a processor.

A restaurant system may include an operation unit 460, a food preparation/delivery (FPD) system 470, a current FPD processes database 480, a restaurant preference lookup table (LUT) 490, and FPD process template database 495.

Each of these units may be implemented as an integrated circuit, and may be controlled by a processor. Further, one or more of the above noted units may be included in a computer.

The UI 410 may initially obtain order data of a food order placed via the UI 410. In an example, a passenger of the AV may select a restaurant from a list of restaurants to order from. The list of restaurants for selection may be preselected by an owner, a driver, or a passenger of the AV, or may be provided based on at least one of a location, food type, consumer rating, current wait times, and the like. Once a restaurant is selected, one or more food items may be displayed for selection. If particular food items are repeatedly selected, such food items may be displayed at the top of the display screen for easier selection. Upon selection of food items, an option to prepay for the food order may be displayed for selection. In an example, the option to prepay may designate the AV to drive to a specific pickup window for quicker service upon arrival at the restaurant. Once the food order is submitted, a display of estimated time of arrival (ETA) and/or expected wait time at the restaurant may be provided.

In an example, an initial route to the selected restaurant may be determined by the routing unit 430 when the restaurant is initially selected or upon submission of the order. However, this aspect of the present disclosure are not limited thereto, such that the initial route determination may be made at any time from the listing of the restaurant to after the submission of the order. In an example, the initial route may be determined in view of other vehicle information received from the other data sources 450. The other vehicle information may include additional information for determining the best route or more accurately judge the estimated time of arrival of the AV at a selected restaurant. The other data sources 450 includes, without limitation, databases containing traffic data, data sources that are able to estimate a number of autonomous vehicles compared to human-driven vehicles on the determined route to the selected restaurant, and databases storing current and predicted meteorological data. Further, the other data sources 450 may be one or more external databases that may connected to the AV via a network.

Further, the UI 410 may obtain initial vehicle data from the routing unit 430. In an example, the initial vehicle data may be obtained in response to obtainment of the order data. Alternatively, the initial vehicle data may be obtained prior to obtainment of the order data to display to a user, expected arrival time for each of the restaurants available for selection. Vehicle data may include, without limitation, data that describes routing information relevant to the selected restaurant, and estimated time of arrival at the selected restaurant. Examples of vehicle data may include, without limitation, (i) direction of the AV will take towards the selected restaurant, (ii) end destination of the route (e.g., at an entrance to a parking lot of the selected restaurant), (iii) AV's ETA, and (iv) potential changes of delays to the ETA. Changes of delays to the ETA may be based on, without limitation, an estimation based on historic data, and an estimation based on a number of human-driven vehicles compared to autonomous vehicles along the route. In an example, vehicles type information (e.g., human-driven vehicles, autonomous vehicles, etc.) may be drawn from other data sources 450. The other data sources 450 may be connected to the AV via a network.

Once the order data and the initial vehicle data are obtained by the UI 410, the UI 410 transmits, via a network, the order data and the initial vehicle data to the FPD system 470. The FPD system 470 may extract, from the FPD process template database 495, one or more FPD process templates corresponding to the order data. For example, the FPD process template database 495 may include a number of FPD process templates that may specify how to prepare a particular food item (e.g., bacon cheeseburger, fish tacos, etc.) indicated in the order data. A FPD process template may include a set of process definitions that pertain to either preparation of a meal or delivering of the meal.

Based on the one or more FPD process templates extracted, the FPD system 470 may generate FPD processes to be performed. More specifically, the FPD system 470 may execute, via a processor, the PAR determination algorithm to determine an optimal combination of FPD processes with which to prepare the order received from the AV. Further, the FPD system 470 may, via execution of the PAR determination algorithm, generate partial or facility specific route information, which may indicate a particular order pickup location. In an example, once the AV arrives at an entrance of the restaurant, the partial route information may specify a particular route to take from the entrance of the restaurant to a designated order pickup location, such as a pre-pay pick up location. More specifically, the FPD system 470 may transmit the facility specific route information to the AV upon AV's arrival at the restaurant facility, such as an entrance of the restaurant. However, this aspect of the present disclosure is not limited thereto, such that a passenger may request to display the facility specific route information when a pickup area has been designated for the order.

The FPD system 470 may transmit scheduled instructions to various resources of the operation unit 460 for execution of the generated FPD processes. For example, the FPD system 470 may transmit scheduled instructions to a burger cooking robot, which may specify what to be cooked at specific time intervals. The generated FPD processes are transmitted to the current FPD process database 480 for storage. The current FPD process database 480 may store data relating to a current status of food preparation within the selected restaurant. Further, the current FPD processes database 480 may store progress data relating to a current workload, as well as projected future workloads, of various resources or operations units of the restaurant.

Based on the stored FPD processes and workload of various resources of the restaurant, an estimated time of completion for a food order may be determined by the FPD system 470. Further, the FPD system 470 may retrieve restaurant preferences from the restaurant preference LUT. For example, restaurant preferences may include, without limitation, a number of staff available to work in different areas of the restaurant, and relative priority of various tasks to be performed in the restaurant. Accordingly, the estimated time of completion for the food order may be determined in view of the restaurant preferences. The initial estimated time of completion may be adjusted in view of fluctuations in the workload of various resources or operation units of the restaurant. Further, in view of the estimated time of completion and the vehicle data including estimated time of arrival, a food order may be queued to begin preparation at a particular time, rather than beginning food preparation in accordance with order received. Accordingly, a more freshly prepared food may be provided when the AV arrives at the restaurant to receive the food order.

Once the FPD processes are initially generated and issued for execution, the FPD system 470 may intermittently reassess whether the issued FPD processes are still optimal for the restaurant. In an example, a future delay has a degree of likelihood this may be used to modify the food preparation. In this circumstance, the effect on the change on the food preparation may be dependent on the status of the food preparation. More specifically, a 5-minute delay may have a different implication if the food was uncooked, where the delay could be simply inserted by placing the food in a holding area, versus when the food is already cooked, where the delay may require different equipment to be used, or food to be diverted to a different order, or disposed of.

The FPD system 470 may perform the reassessment at predetermined time intervals or in response to a certain event, such as an unexpected fluctuation in demand (e.g., a tour bus guests arriving at the restaurant). Further, the FPD system 470 may also intermittently reassess whether the AV's route is still optimal in view of the issued FPD processes. In the event that no revision may be warranted, no further action may be taken until a next reassessment is performed.

On the other hand, if a revision to the FPD processes and/or the AV route is determined to be warranted, the FPD system 470 may execute PAR re-optimization algorithm via a processor to generate one or both of a set of revised FPD processes, and a route modification request.

The route modification request may be generated in view of the estimated time of completion for the food order, which may be based on one or more FPD processes being performed. Further, the generated route modification request may be transmitted to the routing unit 430. For example, if the food order is expected to take at least 30 minutes, while the fastest route may take 20 minutes via a toll road, the route modification request may specify the AV to take a local route with no toll. The routing unit 430 in response may route the AV to take local roads taking 30 minutes to avoid paying the toll and to receive the food order with minimal wait time. Transmissions of the route modification request and/or current vehicle data may be performed at predetermined time intervals or in view of an unexpected change in estimated arrival time or food completion time. In an example, an unexpected change may include a change in initial/current estimated arrival time or food completion time by more than a predetermined threshold (e.g., 5 minutes).

The routing unit 430, in response to the received route modification request, may generate a new route. Further, the routing unit 430 may generates current (or updated) vehicle data based on the newly generated route. The current vehicle data is then transmitted to the FPD system 470. In an example, the current vehicle data may include a revised ETA based on the new route.

The FPD system 470, upon receiving the current vehicle data, determines whether a revision to the FPD processes and/or AV route is necessary or warranted. If no such revision is required, the FPD system 470 may request the AV to generate and transmit vehicle data at predetermined intervals or in view of an unexpected change in estimated arrival time or order completion time. If a revision to the AV's routing is required in view of the current vehicle data, the FPD system 470 transmits a new route modification request to the routing unit 430. If a revision to the FPD process is required (e.g., more assistance may be required at a burger station in view of an influx of large orders), the FPD system may revise the FPD processes to be performed. Further, the FPD system 470 may generate corresponding updated or revised scheduled instructions to one or more resources of the operation unit 460. For example, cashiers (e.g., human or robot) may be reallocated to food packaging area for quicker throughput.

While the food order is in process of being prepared, the FPD system 470 may intermittently check to determine whether the FPD processes are being performed in a manner to meet estimated order completion time. More specifically, the FPD system 470 may transmit, to the current FPD processes database 480, FPD processes being performed or scheduled to be performed by the operation unit 460. The current FPD process database 480 in turn may transmit FPD process data, which may indicate current state of food preparation (e.g., burger patty is fully cooked, fries are ready in 4 minutes, and the like). The FPD process data may also indicate present and future workloads of various resources of the operation unit 460. If the FPD system 470 determines that one or more FPD processes are needed to be revised, the FPD system 470 may generate new FPD processes to be executed. Further, if the current AV route is required to be correspondingly revised, the FPD system 470 may also transmit a route modification request.

The FPD system 470 may perform the intermittent checks until the food order is delivered to the AV and/or until the AV exits the restaurant facility.

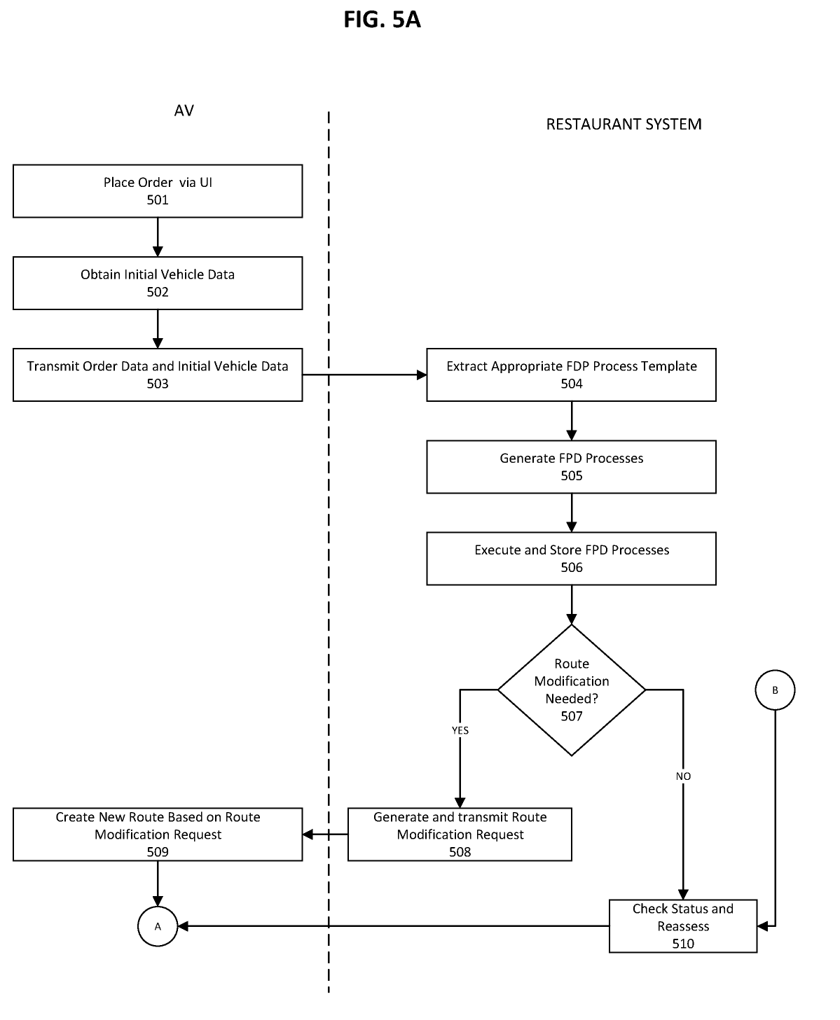

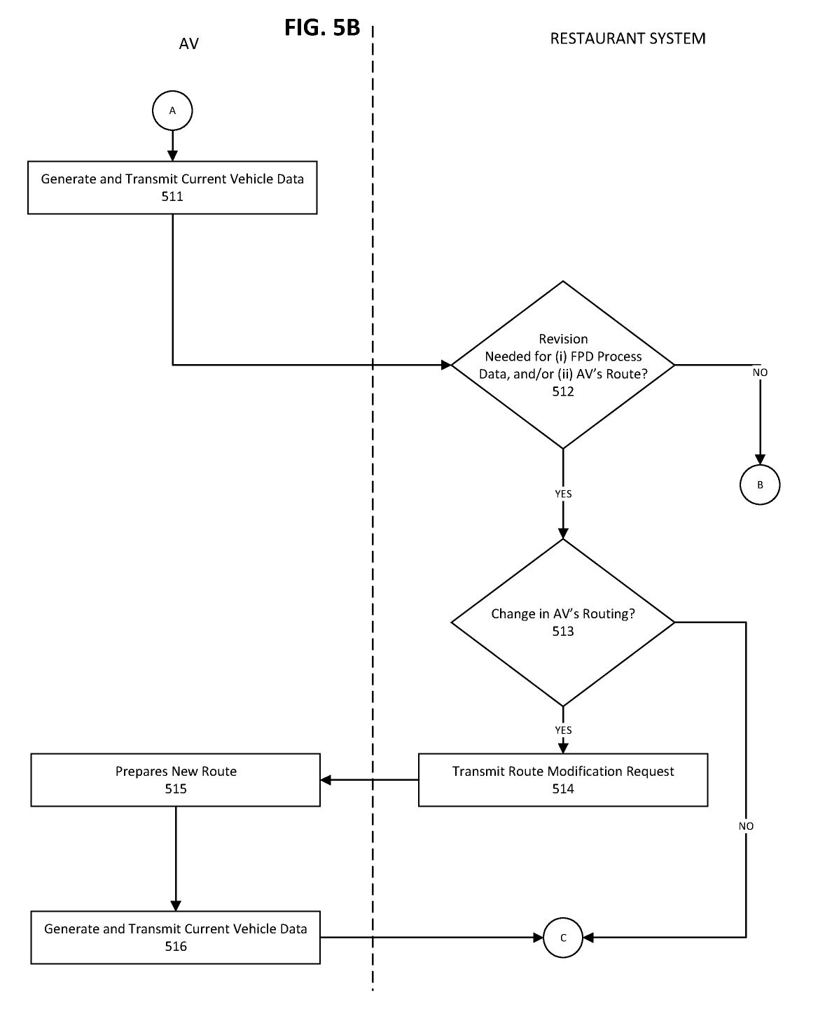

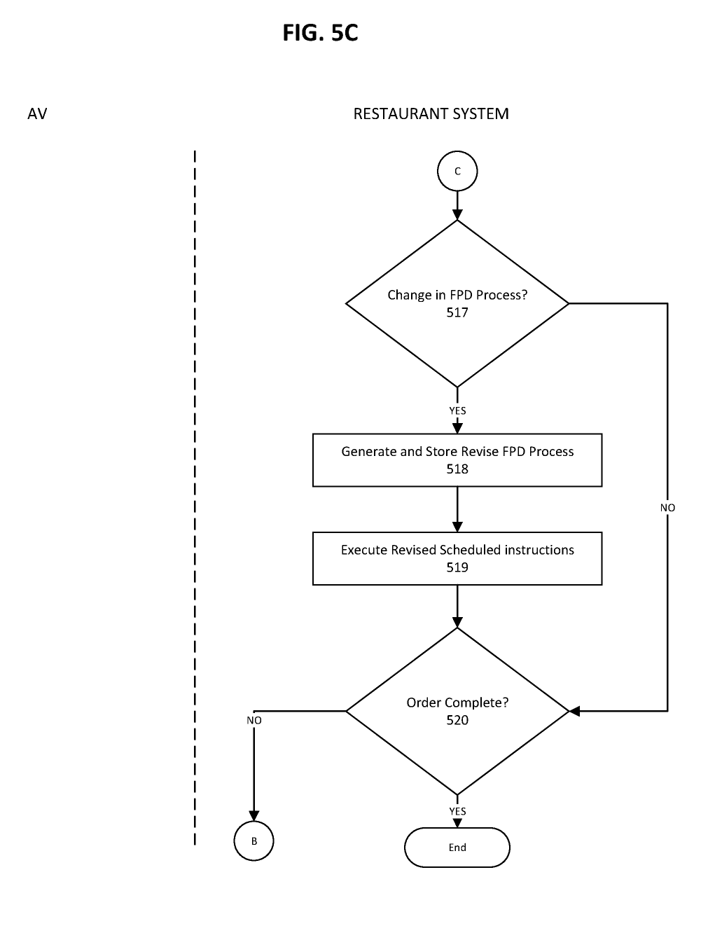

FIGS. 5A-5C shows an exemplary process flow between an AV and a restaurant system for fulfilling an order, according to the one aspect of the present disclosure.

In operation 501, an autonomous vehicle (AV) places a food order at a selected restaurant. The food order may be placed using a user interface of the AV, or a separate mobile device. The order may be placed using a touch input and/or a voice input. The food order may be placed, by a driver/passenger, while the AV is in operation. Alternatively, the food order may be pre-ordered to be transmitted at a designated time specified by the driver/passenger. For example, the food order may be preselected and programmed to be transmitted to a pre-selected restaurant once the AV is in operation at an evening time at a place of employment.

The food order may generate order data, which may include user preference information, such as how the user likes the food to be prepared. For example, user may specify a particular temperature for a steak order, such as well-done or rare. Such information may be stored as a preference, such that it may be transmitted automatically upon placing of an order or may be manually specified during the placing of the order. Such preferences may be saved for certain restaurants for future orders. Further, payment information may be additionally pre-stored, such that the payment may be also transmitted with the order data for quicker delivery of the food order. For example, a restaurant may designate a separate pickup window to deliver prepaid orders.

In operation 502, the AV obtains initial vehicle data for transmission to a restaurant system of the selected restaurant. Vehicle data includes, without limitation, data that describes routing information relevant to the selected restaurant, and estimated time of arrival at the selected restaurant. Examples of vehicle data may include, without limitation, (i) direction of the AV will take towards the selected restaurant, (ii) end destination of the route (e.g., at an entrance to a parking lot of the selected restaurant), (iii) AV's estimated time of arrival (ETA) to the end destination, and (iv) potential changes of delays to the ETA.

Changes of delays to the ETA may be based on, without limitation, an estimation based on historic data, and an estimation based on a number of human-driven vehicles compared to autonomous vehicles along the route. Further, the changes of delays to the ETA may also be based on traffic conditions, weather conditions, sun visibility on route, presence of any incidents (e.g., accidents, police presence, and etc.). Initial vehicle data may be vehicle data available at a time of placement of the food order.

In operation 503, the AV transmits, to the restaurant system, order data pertaining to the food order placed in operation 501, and the initial vehicle data obtained in operation 502.

The restaurant system, upon receipt of the order data and the initial vehicle data, extracts an appropriate food preparation/delivery (FPD) process template in operation 504. The extracted FPD process template may include processes related to preparation of the food order placed in operation 501. For example, definitions pertaining to preparation of a meal may include, without limitation, ingredients, program(s) to be executed by a resource of the restaurant (e.g., robot, human employee, fryer, and the like). Further, definitions pertaining to delivering of the food may specify, without limitation, which drive-through window the order is to be received, and/or process that needs to be followed during the handover of the order.

In operation 505, the restaurant system generates FPD processes based on the FPD template. More specifically, the restaurant system uses the extracted FPD process template and information relating to the restaurant's current operations to generate (i) a set of FPD processes, which may be used to prepare food corresponding to the food order.

In an example, the set of FPD processes may include, without limitation, (i) ingredients and other resources required in preparation of the food order, (ii) identity of one or more operation units set to execute assigned tasks included in the food preparation and delivery, (iii) which location (e.g., delivery window) will be used to handover the completed order, and (iv) which processes will be required to carried out at a time the completed order is handed off to the driver/passenger of the AV.

The generated FPD processes are transmitted to an appropriate resource (e.g., a burger cooking robot) of the restaurant system for execution, and executed in operation 506. More specifically, scheduled instructions may be transmitted to the appropriate resources, which may specify certain operations to be performed at what times or sequence. Further, the generated FPD processes are stored at a database and monitored for their statuses until the order has been completed. For example, designated robots may prepare the food (e.g., cooking of burger patties), pack the order for carry out (e.g., placing a burger in a container and a bag), and deliver or handoff the packed food order to a corresponding customer (e.g., handoff the food order to the customer arriving at the designated food delivery window). Further, if payment has not yet been received, a resource (e.g., cashier robot, a payment intake machine, a cashier, etc.) may be instructed to request payment prior to delivery of the food order.

Also in operation 506, the generated FPD processes are transmitted to a current FPD processes database of the restaurant system for storage in an accessible form with all other FPD processes. Further, progress status data of the FPD processes are also stored at the current FPD processes database. In an example, the progress status data may be based on operational status data provided by the one or more resources of the restaurant.

In operation 507, the restaurant system may determine whether a route modification is needed or warranted in view of the FPD process. For example, if the food order is expected to take at least 30 minutes, while the vehicle data indicates an ETA of 20 minutes via a toll road, the route modification request may specify the AV to take a local route with no toll to save money and minimize wait time at the restaurant.

If the restaurant system determines that the route modification is needed, the restaurant system generates a route modification request and transmits the route modification request to the AV in operation 508. The route modification request may request the AV to change its route, speed or the like. The route modification request may be for a partial route or a full route. Further, the route modification request may include information that allows the AV's routing unit to create a route. In an example, the route modification request may be used by the AV to arrive at a specified location of the restaurant at a specified time. Further, in an example, the route modification request may include, without limitation, (i) an estimated time to arrive at the designated handover or receipt location (e.g., food delivery window), (ii) a route to be taken while on grounds of the restaurant, and (iii) a direction along with to approach the designated location of the restaurant.

In operation 509, the AV creates or generates a new route towards the selected restaurant based on the route modification request. More specifically, the AV creates a set of vehicle operation instructions, which are executed for the AV to travel along the new route.

If the restaurant system determines that the route modification is not needed in operation 507, the restaurant system intermittently check to determine whether the FPD processes are being performed in a manner to meet estimated order completion time in operation 510. The restaurant system may perform the intermittent checks at predetermined intervals, in view of AV's travel progress, or in response to a particular event (e.g., completion of a food preparation step, such as cooking of a burger patty). Further, re-checks may be performed to verify that food preparation is being performed in view of initial vehicle data traveling along the new route. For example, re-checks may be performed to verify that expected food preparation time is in line with expected arrival time of the AV at the designated location for food handoff or delivery.

In operation 511, current vehicle data is generated and transmitted to the restaurant system. The current vehicle data may be generated for transmission in response to new route information, in response to an event (e.g., accident, unexpected delays, etc.), or at predetermined time intervals (e.g., every minute) or distance intervals (e.g., every mile). If the AV determines that the AV is no longer likely to arrive at the restaurant at an estimated time of arrival in view of the occurrence of the event, the AV may generate a flag to generate and transmit current vehicle data including a revised estimated time of arrival.

For example, the current vehicle data may be updated vehicle data that is supplied after the order is initially transmitted by the AV or after last transmission or obtainment of the vehicle data. Current vehicle data includes, without limitation, data that describes routing information relevant to the selected restaurant, and estimated time of arrival at the selected restaurant based on current location of the AV. Examples of current vehicle data may include, without limitation, (i) direction of the AV will take towards the selected restaurant from the current location, (ii) end destination of the route (e.g., at an entrance to a parking lot of the selected restaurant), (iii) AV's ETA from the current location, and (iv) potential changes of delays to the ETA from the current location.

In operation 512, the restaurant system determines whether a revision is needed for the FPD process data and/or AV's route. In an example, the restaurant system may assess whether the FPD processes currently in place are still optimal for the restaurant in view of the current or updated vehicle data. In another example, the restaurant system may assess whether the FPD processes are being performed in a manner to meet estimated order completion time.

In an example, processes that may be used to optimize the restaurant processes or FPD process, and/or the AV's route may include, without limitation, (i) describing each FPD processes as series of actions and pauses, (ii) providing an order with associated finishing time and delay time, (iii) associating each operation within the FPDS processes with an operating unit or a resource (e.g., machine, robot, a human employee and etc.), and (iv) scheduling all of the FPD processes and calculating a queue at each resource.

More specifically, each of the FPD processes may be described as a series of actions and pauses, at which a food component may be stored in a temporary location. Each of the pauses may be associated with a minimum and maximum periods. For example, a cooked burger patty may be placed in a warming area for a certain period of time prior to being assembled as a burger. The minimum and maximum periods may allow for the food component to be at an appropriate condition for delivery to a customer. For example, fries may have a required waiting period to ensure that they are not too hot for consumption, and have a maximum holding period to ensure that the food is at a proper serving temperature.

Further, as noted above, each order may have an associated finishing time and a delay time. For example, the finishing time may specify a time at which the order is estimated to be ready for delivery. The delay time may specify a delay that can be tolerated by a customer (i.e., time the customer may be willing to wait to receive the food upon arrival by the AV). Further, the delay time may specify a delay that is attributed by a route change, which may be adjusted for without introducing arduous route changes.

Once all of the FPD processes are scheduled, and queue at each resource is calculated, the order of the FPD processes may be changed using each resource. Further, pauses introduced in the FPD processes are changed until an optimization parameter is minimized or maximized. The optimization parameter include, without limitation, a number of orders fulfilled within a half hour period, reducing or minimizing a number of users that receive their orders outside of their allowable delay time, and reducing or minimizing an amount of pause time introduced to FPD processes. Although exemplary optimization strategies are provided, this aspect of the present disclosure is not limited thereto, such that other optimization strategies based on a theory of constraints may be selected. Further, optimization based on machine learning may also be used to optimize the restaurant system.

Further, the restaurant system may further assess whether the AV's route can be revised to improve or optimize the FPD processes in operation 513. More specifically, in operation 513, whether a change in the AV's route is warranted is determined. For example, the change in the AV's route may be determined to be warranted if the resulting wait time increases above a predetermined threshold (e.g., 5 minutes).

If it's determined that the change in the AV's route is warranted in operation 513, a route modification request is transmitted to the AV in operation 514. On the other hand, if it's determined that the change in the AV's route is unwarranted in operation 513, a further determination of whether a change in the FPD processes is warranted is determined in operation 517.

In operation 515, the AV generates a new route in response to the received route modification request.

In operation 516, the AV generates current (or updated) vehicle data based on the new route, and transmits the generated current vehicle data to the restaurant system.

In operation 517, a further determination of whether a change in the FPD processes is warranted is determined. If the change in the FPD processes is determined as being warranted in operation 517, the restaurant system generates revised FPD processes in operation 518. Further, in operation 518, the revised FPD processes are stored for monitoring of their respective progress status. For example, a progress status of a FPD process of cooking a burger patty may be stored for monitoring. If the change in the FPD processes is determined as not being warranted in operation 517, the restaurant system determines whether the order preparation is completed and ready for pickup in operation 520.

In operation 519, the restaurant system generates corresponding updated or revised scheduled instructions for execution of the FPD processes by one or more resources (e.g., robots, human employees, machines, etc.) of the restaurant.

In operation 520, the restaurant system determines whether the order preparation is completed and ready for pickup. If the order preparation is not completed, the method proceed back to operation 510, in which the restaurant system intermittently checks to determine whether the FPD processes are being performed in a manner to meet estimated order completion time. If the order preparation is determined to be completed in operation 520, the method ends. In an example, the order preparation is determined to be completed when the order is handed over to a passenger of the AV. Alternatively, the order preparation is determined to be completed when the AV leaves the restaurant facility.

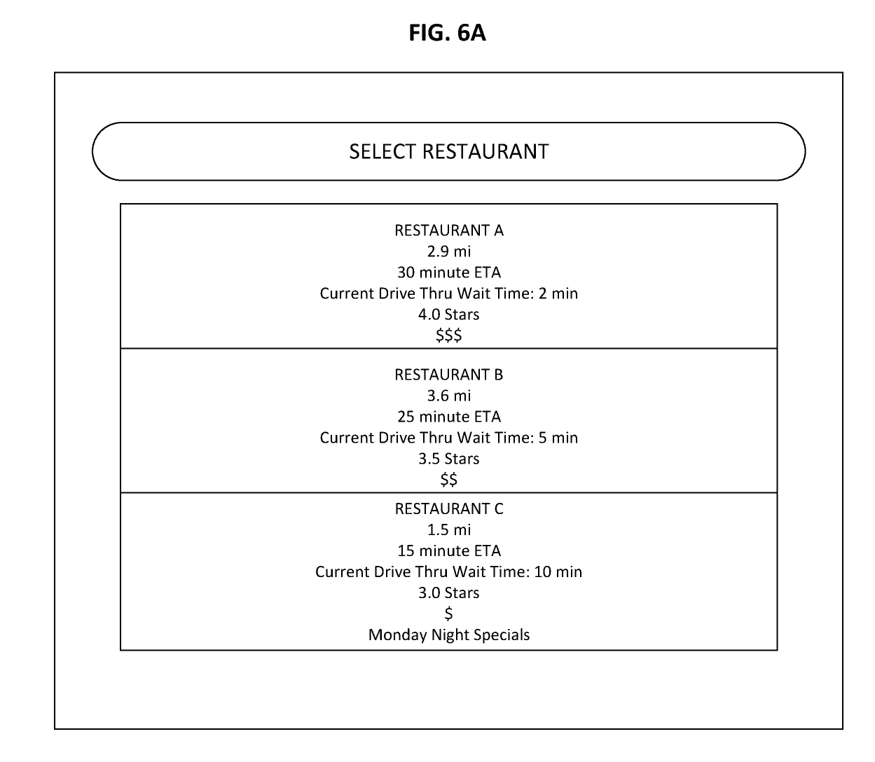

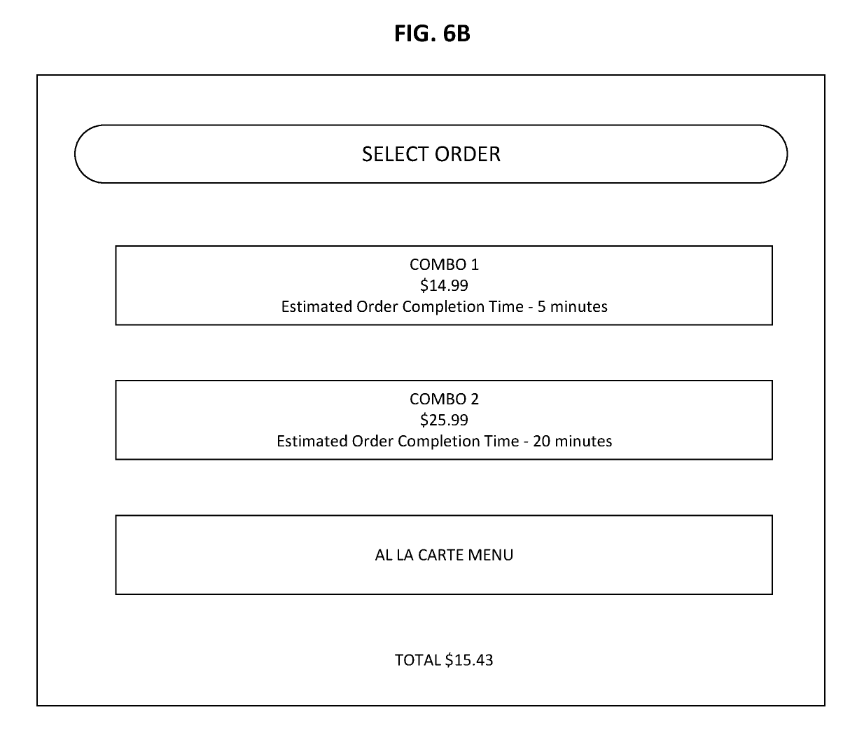

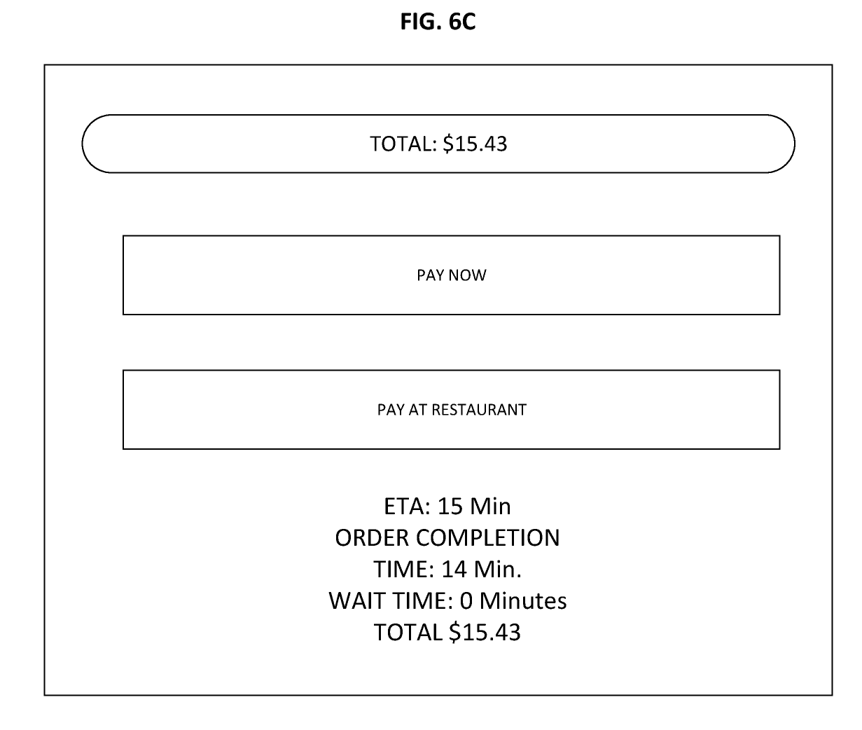

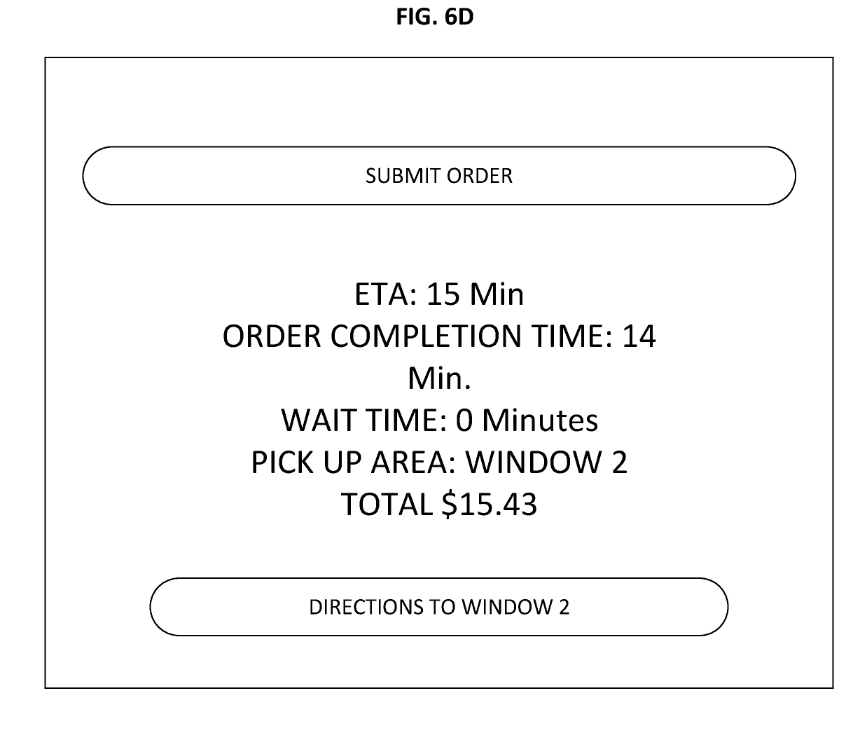

FIGS. 6A-6D show exemplary displays of an AV user interface (UI) for placing an order, according to the one aspect of the present disclosure.

FIG. 6A may illustrate a display screen of the AV UI for selecting a restaurant. In an example, a listing of restaurant may be provided based on initial vehicle data of the AV. More specifically, a listing of restaurants may be provided based on one of more of a restaurant's locational proximity to the AV, estimated time of arrival to the restaurant, average wait times, restaurant rating, expected costs, particular specials (e.g., happy hour specials, Monday night specials, and etc.) and the like. Further, the AV UI may be set to specify user preferences. For example, a user may specify that only restaurants that can be reached within 20 minutes may be displayed.

FIG. 6B illustrates an order selection screen for the restaurant selected on FIG. 6A. FIG. 6B may display a list of menu items that can be selected for order. The order selection menu may display a menu item with corresponding price information and estimated order completion time. As illustrated in FIG. 6B, menu order item “combo 1” may have an estimated order completion time of 5 minutes, whereas menu order item “combo 2” may have an estimated order completion time of 20 minutes. Further, the AV UI may be set to specify user preferences. For example, a user may specify that only menu order items having an estimated order completion time less than or equal to the estimated time of arrival of the AV to be displayed for minimizing wait times.

FIG. 6C illustrates an optional payment screen. In an example, an option may be provided to allow a passenger of the AV to provide prepayment prior to receiving the complete order to expedite the order pickup process. Further, in an example, the selected restaurant may have designated areas or windows designated for prepaying customers for quicker order pick up process. Also on the payment screen, a summary of relevant information may be provided, such as estimated time of arrival, order completion time, expected wait time, and total due. However, this aspect of the present disclosure is not limited thereto, such that additional information may be provided.

FIG. 6D illustrates an order submission screen. The order submission screen may display an order submission button, as well as a summary of relevant information. The summary of relevant information may display estimated time of arrival, order completion time, expected wait time, pick up area, and total due. However, this aspect of the present disclosure is not limited thereto, such that additional information may be provided. Further, the order submission screen may have a button to request a facility specific route to the designated pick up area. For example, the facility specific route may specify route information from an entrance of the restaurant to window 2. Although the button to request the facility specific route is illustrated, this aspect of the present disclosure is not limited thereto, such that such facility specific route may be automatically displayed upon AV's arrival to the entrance of the restaurant facility.

In view of the above-described exemplary embodiments, several benefits may be realized. For example, a restaurant operator may be able to optimize efficiencies of their respective restaurant to improve equipment and/or staff utilization. Further, a restaurant may be able to offer a wider range of menu choices, with increased customer personalization, while reducing wait times for the customers to receive their order. In addition, based on the above noted disclosures, passengers (including a driver in less automated AVs) may be able to order food from the AV, and pick up the ordered food from a restaurant with less or minimal wait times, thereby increasing customer satisfaction and retention.

Although the exemplary embodiments of the present application have been described with respect to a restaurant, this aspect of the present disclosure is not limited thereto, such that they may be used in a retail environment and other applicable industries.

The exemplary embodiments of the present disclosure provide a system that covers an autonomous vehicle and restaurant operation, whereby the routing and estimated arrival time of the autonomous vehicle, and also the processes used by the restaurant to prepare and deliver a food order are optimised together. Accordingly, an overall advantageous situation is achieved for both the autonomous vehicle user and restaurant operator.

Further, the exemplary embodiments of the present disclosure provide restaurant optimization that is made across many processes within the food preparation and delivery system of the restaurant, and includes multiple customer orders. For example, food order may be prepared in accordance with a defined process, where the scheduling of the steps within that process are controlled by an overall optimization algorithm. The optimization algorithm provides optimization across multiple food orders.

Further, this aspect of the present disclosure provides an AV that calculates its anticipated time of arrival at the restaurant, whereby (i) an algorithm may be executed to assess potential risk of delay due to future uncertainty of traffic, and (ii) determine an estimated time of arrival of the AV at the restaurant, and (iii) another algorithm that is executed to assess possible tolerances in the estimated time of arrival, due to modification of the vehicles route/motion, that may be acceptable to the vehicles passengers or operators.

In addition, aspects of the present disclosure provides an algorithm that is executed, after assessing the time of arrival of the AV and the food preparation, to optimize both sub-systems as a single system, such that the vehicle arrives to a designed pick-up area or location while the food is freshly prepared or prepared within a time-period where the quality of the food is deemed satisfactory to the customer.

Further, this aspect of the present disclosure provides continually monitoring the future route of the AV, and likely traffic on that route, and re-executing the optimization algorithms to provide a dynamic optimization of food preparation and vehicle operation.

It is foreseen that, in future societies in which autonomous vehicles will be common, the need for a driver to effectively utilize time he or she will spend inside an autonomous vehicle will increase. Examples as to the manner of spending time inside an autonomous vehicle are things relating to taking of a meal.

For example, assume that the driver of an autonomous vehicle wants to stop by a restaurant to pick up food (e.g., via a drive-through) while driving toward a destination. In this case, it is necessary for the driver to change the destination temporarily to the location of the restaurant, and after stopping by the restaurant, change a route again to go to the final destination from the restaurant. However, in US2016/0232625A, no consideration is given to the case that the driver of an autonomous vehicle changes the destination temporarily to the location of, for example, a drive-through of a restaurant to pick up food, and then changes a route so as to reach the final destination. No consideration is given either to how to allow the driver to effectively utilize time he or she spends inside an autonomous vehicle during an autonomous drive.

Furthermore, to allow a user (e.g., the driver or a passenger) to utilize time he or she spends inside an autonomous vehicle, it is expected that the autonomous vehicle and a terminal of a restaurant (or restaurant-side terminal) capable of providing a drive-through service cooperate with each other in a highly systematic manner, as what relates to taking of a meal. That is, the convenience of a user would be increased by making various adjustments while mediating between a restaurant-side terminal and the autonomous vehicle by means of a server or the like. Examples of such adjustment items are selection of a restaurant (e.g., a fast food restaurant capable of providing a drive-through service) to drop in at, an order from a menu, reservation of a restaurant, a change of a route to a destination, and a waiting time (e.g., a reception waiting time in the case of a drive-through). If such adjustments are realized so as to be seamless, a user of a service of a restaurant or the like (e.g., the driver of a passenger) can make good use of a time free of stress while he or she is in the vehicle and, on the other hand, a service provider, such as a restaurant, can expect efficient restaurant operation and increase of the ratio of attracting customers. In view of the above, a description will be made below of examples of an autonomous drive control device, a vehicle, and a demand adjustment system that, when a user, such as a driver, wants to use a drive-through of a service facility (e.g., restaurant, coffee shop, grocery store, and etc.), changes adaptively a route to a destination so that it includes, for example, a drive-through restaurant in response to simple manipulations of the user and increases the convenience in an appropriate manner by allowing the user to effectively utilize time he or she spends during an autonomous drive. An embodiment as a specific disclosure of an autonomous drive control device, a vehicle, and a demand adjustment system according to this aspect of the present disclosure will be hereinafter described with reference to the accompanying drawings. However, unnecessarily detailed descriptions may not be made; for example, descriptions of well-known items and redundant descriptions of substantially the same units etc. may be omitted. This is to prevent the following description from becoming unnecessarily redundant and thereby allow those skilled in the art to understand it more easily. The following description and the accompanying drawings are provided to allow those skilled in the art to understand this disclosure sufficiently, and are not intended restrict the subject matter described in the claims.

In this aspect of the present disclosure, when a user makes manipulations for input of demands relating to an order from a menu and directed to a restaurant (e.g., drive-through), a vehicle including an autonomous drive control device according to the present disclosure (hereinafter may be referred to as a “self-vehicle”) receives, from a demand adjustment server, a proposal of the restaurant that satisfies the demand, makes an operation for accepting it during an autonomous drive to a destination, and merges a guide route to the restaurant with a route to the destination. The vehicle sets, as a new route, a route obtained by merging the guide route, and performs an autonomous drive along the new route. The user is the driver or a passenger of the vehicle, which also applies to the following description. The guide route is a route generated by the demand adjustment server and, more specifically, a route along which to guide the self-vehicle from its current position to a restaurant that satisfies a demand of the user.

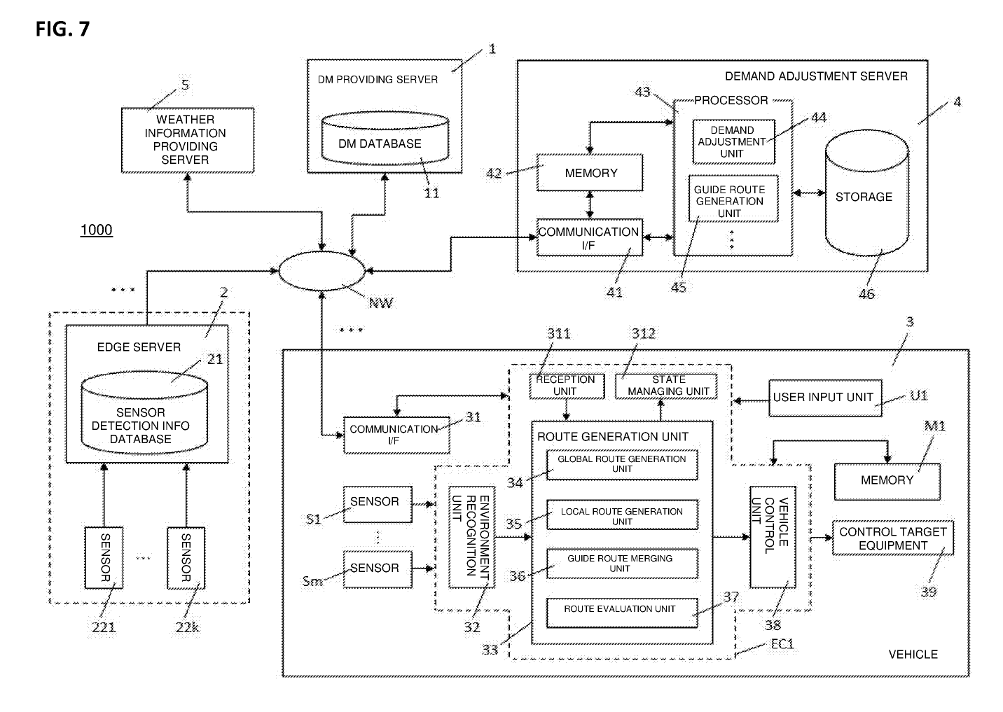

FIG. 7 is a block diagram showing an exemplary configuration of a demand adjustment system that is centered by a vehicle including an autonomous drive control device, according to another aspect of the present disclosure. More specifically, FIG. 7 is a block diagram showing an exemplary configuration of a demand adjustment system 1000 that is centered by a vehicle 3 including an autonomous drive control device EC1, according to this aspect of the present disclosure. The demand adjustment system 1000 is configured so as to include a DM (dynamic map) providing server 1, edge servers 2, a vehicle 3, a demand adjustment server 4, and a weather information providing server 5. The DM providing server 1, the edge servers 2, the vehicle 3, the demand adjustment server 4, and the weather information providing server 5 are connected to each other by a network NW so as to communicate with each other. The network NW is a wireless communication network, such as the Internet or a wireless LAN (local area network).

The DM providing server 1 has a DM database 11 (e.g., HDD (hard disk drive)) that holds a dynamic map which is road environment information necessary to realize autonomous driving of the vehicle 3. The DM providing server 1 updates the dynamic map stored in the DM database 11 repeatedly on a regular basis. The DM providing server 1 acquires the dynamic map data from the DM database 11 and sends the acquired data to the vehicle 3 and the demand adjustment server 4 every time it receives a request from the vehicle 3 or the demand adjustment server 4. In an example, the request from the vehicle 3 or the demand adjustment server 4 may arrive on a regular basis.

For example, the dynamic map is digital map data obtained by combining static, high-resolution 3D map data with road congestion information and information of positions where a dynamic change, such as a traffic restriction due to a traffic accident or road construction, has occurred. Using a dynamic map supplied from the DM providing server 1, the vehicle 3 can perform an autonomous drive while estimating information about a surrounding environment correctly based on a detection output of a sensor (e.g., millimeter-wave radar, ultrasonic sensor, or optical camera) installed in the self-vehicle. The edge servers 2 are disposed as appropriate (e.g., plural edge servers 2 are disposed) to judge, through detection and information collection, a real-time situation of an environment (e.g., a traffic jam or a dynamic change such as a traffic accident or road construction) of the road on which the vehicle 3 is driving on. For example, k sensors 221-22k (k: integer that is larger than or equal to 2) are connected to each edge server 2, which has a sensor detection information database 21 for holding information detected by the individual sensors 221-22k (sensor detection information). To detect a real-time road environment situation, each of the sensors 221-22k may be installed on a utility pole, a pole beside an expressway, a guard rail, or the like.

Each edge server 2 judges that a traffic jam, a traffic accident, road construction, or the like has occurred based on sensor detection information detected by each of the sensors 221-22k, and sends road information including information indicating a position of occurrence of that event to the DM providing server 1 and the vehicle 3. This road information will be used when the dynamic map of the DM providing server 1 is updated.

The vehicle 3 is configured so as to include a user input unit U1, sensors S1-Sm (m: integer that is larger than or equal to 2), a memory M1, a communication interface 31, an environment recognition unit 32, a route generation unit 33, a vehicle control unit 38, and control target equipment 39. The vehicle 3 is of autonomous drive level-1 or higher. However, the following description will be made with an assumption that the vehicle 3 is of autonomous drive level-3 for ease of explanation. The user input unit U1, the sensors S1-Sm, the memory M1, the communication interface 31, the environment recognition unit 32, the route generation unit 33, the vehicle control unit 38, and the control target equipment 39 are connected to each other by a vehicular network such as a CAN (Control Area Network) so as to be able to exchange data or information with each other.

The vehicle 3 is equipped with the autonomous drive control device EC1, which is an example controller for controlling an autonomous drive. It is said that to realize autonomous driving of autonomous drive level-1 in a vehicle the vehicle needs to be provided with three elements, that is, recognition, judgment, and manipulation. In this connection, the autonomous drive control device EC1 of this aspect of the present disclosure is equipped with units capable of performing respective kinds of processing that correspond to these three elements. More specifically, the vehicle 3 includes the environment recognition unit 32, the route generation unit 33, and the vehicle control unit 38 that correspond to the recognition element, the judgment element, and the operation element, respectively. In an example, one or more of the environment recognition unit 32, route generation unit 33, and the vehicle control unit 35 may be implemented by a processor or an integrated circuit.

The autonomous drive control device EC1 is implemented using an ECU (electronic control unit), for example. The autonomous drive control device EC1 may be implemented either as a single ECU or as plural ECUs which correspond to the environment recognition unit 32, the route generation unit 33, and the vehicle control unit 38, respectively. Another manner of implementation is possible in which one of the environment recognition unit 32, the route generation unit 33, and the vehicle control unit 38 is one ECU and the other two are another ECUs.

The autonomous drive control device EC1 operates according to programs and data stored in the memory M1. More specifically, in the autonomous drive control device EC1, the route generation unit 33 generates a route of an autonomous drive based on outputs of the environment recognition unit 32. The autonomous drive control device EC1 performs an autonomous drive along a route generated by the route generation unit 33 as the vehicle control unit 38 controls the control target equipment 39. The autonomous driving of the vehicle 3 includes a function of stopping the vehicle 3 by activating the brake immediately before it collides with an obstacle (e.g., another 4-wheel vehicle, a 2-wheel vehicle such as a motorcycle, a pedestrian, a guard rail, a utility pole, or a facility such as a restaurant; this also applies to the following description). The autonomous driving of the vehicle 3 also includes a function of causing the vehicle 3 to follow another vehicle immediately ahead in such a manner that a prescribed distance is kept between the vehicle 3 and the other vehicle, and a function of controlling the steering of the vehicle 3 so that it does not go out of the lane. However, these functions are just example of the autonomous driving. The latter may include other functions.

The user input unit U1, which is a device that allows a user (e.g., the driver of a passenger of the vehicle 3) to input various kinds of data or information, receives an operation of the user on a destination setting picture, image or screen (not shown) displayed on, for example, an HMI (human-machine interface; not shown) installed in the vehicle 3. The user input unit U1 outputs, to the autonomous drive control device EC1, information (of a destination, for example) that has been input as a user instruction.

As described later in detail, in addition to the destination setting picture, image or screen, a picture, image or screen (not shown) for selection of a restaurant (that is, a restaurant that the vehicle 3 can drop in at during an autonomous drive and can provide a drive-through service) proposed by the demand adjustment server 4 in response to user manipulations is displayed on the HMI. The user input unit U1 allows the user to input an operation (e.g., an approval operation for approving the proposed restaurant) to the restaurant selection picture, image or screen.

The sensors S1-Sm, which are installed in the vehicle 3 to detect an environment surrounding the vehicle 3, outputs pieces of information (hereinafter referred to as “detection outputs”) detected by the respective sensors S1-Sm to the environment recognition unit 32. The sensors S1-Sm include a GPS (global positioning system) receiver, a vehicle camera, an around view camera, radars, and laser range finders.

The GPS receiver which is an example sensor receives plural signals that are sent from plural GPS satellites and each of which indicates a time and a position (coordinates) of a GPS satellite, and calculates a position of the GPS receiver (i.e., a position of the vehicle 3) based on the received signals. The GPS receiver outputs position information of the vehicle 3 to the autonomous drive control device EC1.

The vehicle camera which is an example sensor is a camera having an imaging device such as a CCD (charge-coupled device) or a CMOS (complementary metal-oxide-semiconductor) sensor. The camera is installed at the center of a front portion of the vehicle body of the vehicle 3 and shoots with a front central range as a detection range for capturing of images. More specifically, the camera detects an obstacle (mentioned above) existing ahead of the self-vehicle and a traffic light. Capable of performing signal processing using data of captured images, the camera can detect information indicating a relationship between an obstacle detected by the image processing and the self-vehicle (e.g., information indicating a speed and a position of the obstacle relative to the self-vehicle) and also detect a position and a size of a traffic light and a color of a turned-on light.

The around view camera, which is an example sensor, includes multiple cameras that are installed, for example, at front positions (e.g., two cameras), rear positions (e.g., two cameras), and side positions (e.g., two cameras) of the vehicle body of the vehicle 3. The around view camera detects white lines in the vicinities of the vehicle 3, other vehicles in the adjacent lane(s), and other things.

The radars, which are example sensors, are plural (e.g., two) radars installed at a front position and a rear position of the vehicle body of the vehicle 3. Alternatively, only one radar may be installed at a front position of the vehicle body of the vehicle 3. For example, each radar is a millimeter-wave radar, a sonar radar, or a LiDAR (Light Detection and Ranging, Light Imaging Detection and Ranging). Each radar detects a distance between the self-vehicle and an obstacle and, furthermore, a direction of the obstacle as viewed from the self-vehicle by emitting ultrasonic waves or electromagnetic waves such as millimeter waves with scanning in a limited angular range, receiving reflection waves, and detecting time differences between an emission start time and reflection waves reception times.

The laser range finders, which are example sensors, are installed at a front-right position, a front-left position, a right side position, a left side position, a rear-right position, and a rear-left position of the vehicle body of the vehicle 3, respectively. Each laser range finder detects an obstacle (mentioned above) that exists on the front-right, front-left, right, left, rear-right, or rear-left of the vehicle 3. More specifically, each laser range finder detects a distance between the self-vehicle and an obstacle and, furthermore, a direction of the obstacle as viewed from the self-vehicle by emitting laser light with scanning in a prescribed, wide angular range, receiving reflection light, and detecting time differences between an emission start time and reflection light reception times.

The sensors that constitute the sensors S1-Sm are not limited to a GPS receiver, a vehicle camera, an around view camera, radars, and laser range finders, and may include, without limitation, an acceleration sensor, a geomagnetic sensor, a tilt sensor, an air temperature sensor, an air pressure sensor, a humidity sensor, and an illuminance sensor.

The memory M1 may include a RAM (random access memory) and a ROM (read-only memory), for example. The memory M1 temporarily holds programs and data that are necessary for operation of the autonomous drive control device EC1 and data or information generated during its operation. For example, the RAM is a work memory that is used during operation of the autonomous drive control device EC1. For example, the ROM stores and holds, in advance, programs and data for control of the autonomous drive control device EC1.

The communication interface 31 includes a communication circuit capable of exchanging, through a communication, data or information with the external devices (i.e., DM providing server 1, edge servers 2, demand adjustment server 4, and weather information providing server 5) that are connected to the vehicle 3 by a network NW. The communication interface 31 outputs data or information transmitted from each of the above external devices to the autonomous drive control device EC1 and sends data or information that is received from the autonomous drive control device EC1 to one of the above external devices. In FIGS. 1 and 7, the communication interface (31 or 41) is abbreviated as “communication I/F” for the sake of convenience, that is, to simplify the figures.

A reception unit 311 receives, via the communication interface 31, information sent from the demand adjustment server 4, and indicates a guide route to a facility (e.g., restaurant A (described later)) that satisfy a demand relating to an order of a user when manipulations of inputting the demand are made through the user input unit U1.

A state managing unit 312 sets, as a mode indicating a state of the vehicle 3, a guide mode indicating a state that the vehicle 3 is being guided to a facility (e.g., restaurant A (described later)) when information indicating a guide route transmitted from the demand adjustment server 4 is added to (merged with) information indicating a route to a destination by a guide route merging unit 36 of the route generation unit 33 (described later).

The environment recognition unit 32 recognizes a surrounding environment, including a current position, of the vehicle 3 (e.g., self-vehicle) based on detection outputs (described above) of the respective sensors S1-Sm of the vehicle 3. The environment recognition unit 32 outputs surrounding environment information, including the current position, of the vehicle 3 to the route generation unit 33.

The route generation unit 33 generates, through a calculation, based on an output of the environment recognition unit 32, a route (i.e., local roads, an expressway, or a combination thereof) along which the vehicle 3 is to run in doing an autonomous drive to a destination that has been set through the user input unit U1. The route generation unit 33 includes, as functional units, a global route generation unit 34, a local route generation unit 35, a guide route merging unit 36, and a route evaluation unit 37. In an example, one or more of the global route generation unit 34, the local route generation unit 35, the guide route merging unit 36, and the route evaluation unit 37 may be implemented by a processor or an integrated circuit.

The global route generation unit 34 generates a global route (in other words, a running route) from a current position of the vehicle 3 to a destination desired by a user. The method for generating a global route from a current position of the vehicle 3 to a destination is a known technique and hence its detailed description is omitted.

The local route generation unit 35 calculates a route (i.e., local route) for avoiding collision with obstacles (mentioned above) in a drive along a local route from node corresponding to a current location to the next node among plural nodes constituting a global route generated by the global route generation unit 34 using, for example, dynamic map data supplied from the DM providing server 1 and weather information supplied from the weather information providing server 5. As a result, the autonomous drive control device EC1 allows the vehicle 3 to perform an autonomous drive more properly and seamlessly by, for example, bypassing the position of a traffic restriction or the like that has occurred on the local route taking a real-time traffic situation and weather information into consideration.

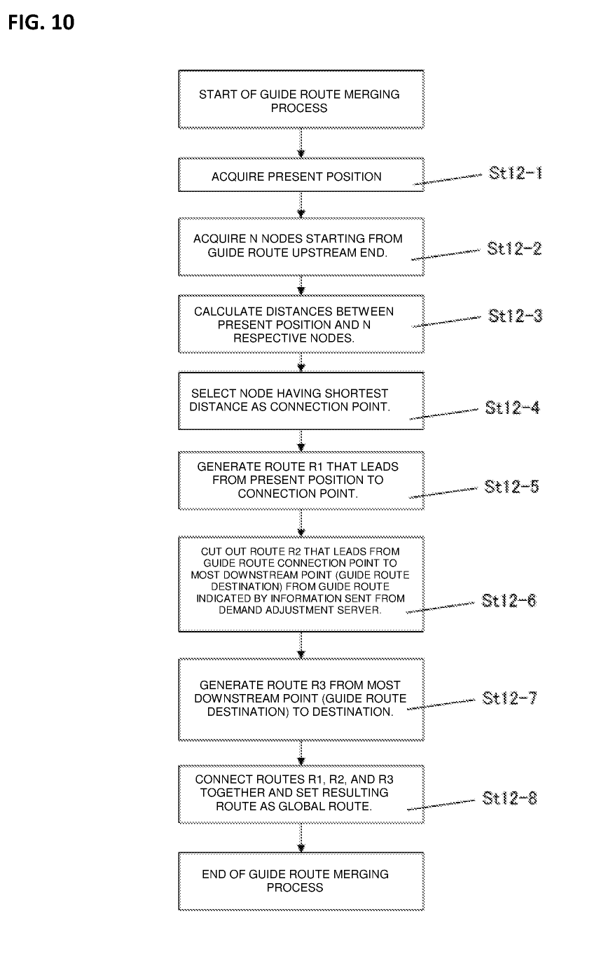

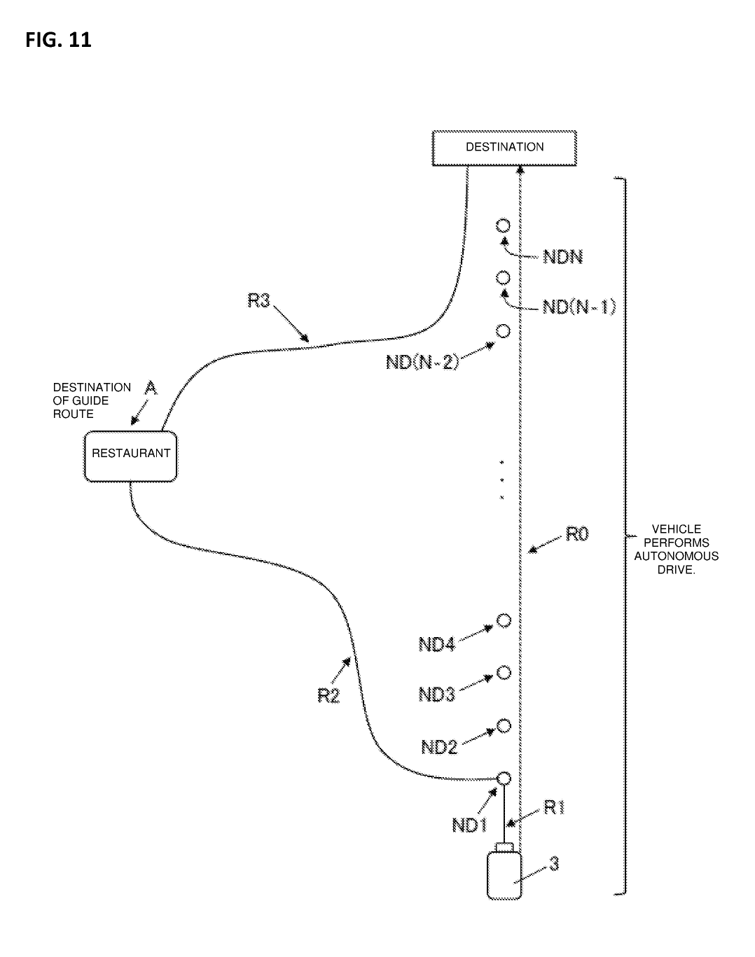

The guide route merging unit 36 merges (or adds) a route (i.e., guide route) from a current position of the vehicle 3 to a restaurant (example facility) to drop in at with (or to) a global route (i.e., route to a destination) generated by the global route generation unit 34, in response to an approval operation (described later) that a user makes during an autonomous drive to a destination of the vehicle 3. With this measure, the autonomous drive control device EC1 can add the route to a restaurant (e.g., drive-through) that the vehicle 3 is to drop in at halfway to the destination in an interruptive manner by a simple operation for approving a restaurant that satisfies a demand of the user. Thus, this allows the user in the vehicle 3 doing an autonomous drive to utilize a time he or she spends in the vehicle 3. A detailed operation of the guide route merging unit 36 will be described later with reference to FIGS. 10 and 11.

The route evaluation unit 37 evaluates objectively the properness of a route generated by the global route generation unit 34 or a route obtained by merging by the guide route merging unit 36 according to a prescribed algorithm. The route evaluation unit 37 evaluates a generated route as to whether an autonomous drive is possible that brings the vehicle 3 to the destination before a desired arrival time that is set by a user on the basis of, for example, traffic regulations effective along the route, presence/absence of an obstacle, and an arrival time prediction result, and calculates a score as an evaluation result. If the calculated score is smaller than a prescribed threshold value, the route evaluation unit 37 instructs the global route generation unit 34 to generate another global route (i.e., instructs the global route generation unit 34 to generate a global route again). The prescribed threshold value may either be set in the algorithm of the route evaluation unit 37 or be stored in the memory M1 as data so as to be read out of the memory M1 and referred to at the time of evaluation. The vehicle control unit 38 calculates control values necessary to control the control target equipment 39 for an autonomous drive, such as an accelerator throttle position of the vehicle 3, a braking force of the vehicle 3, a steering angle, and blinker on/off timing. For example, control values are calculated so that the vehicle 3 runs along a route that is generated by the route generation unit 33 of the autonomous drive control device EC1. The route is generated by the route generation unit 33 through a calculation and input to the vehicle control unit 38. The vehicle control unit 38 sends the calculated control values to respective actuators (e.g., steering actuator, accelerator pedal actuator, brake actuator, and blinker on/off controller) for driving the control target equipment 39 (e.g., steering wheel, accelerator pedal, brake, and blinkers).

The control target equipment 39 is equipment installed in the vehicle 3 and operation-controlled by the vehicle control unit 38 during an autonomous drive. For example, the actuators for driving the control target equipment 39 are the steering actuator, the accelerator pedal actuator, the brake actuator, and the blinker on/off controller. However, the present disclosure is not limited to this case.

The steering actuator is connected to the steering wheel (not shown) of the vehicle 3, and controls operation of the steering wheel (in other words, maintains or changes the running direction of the vehicle 3) during an autonomous drive according to a steering wheel control signal received from the vehicle control unit 38.

The accelerator pedal actuator is connected to the accelerator pedal (not shown) of the vehicle 3, and controls operation of the accelerator pedal (in other words, maintains or changes the vehicle speed of the vehicle 3) during an autonomous drive according to an accelerator pedal control signal received from the vehicle control unit 38.

The brake actuator is connected to a brake mechanism (hereinafter referred to as a brake; not shown) of the vehicle 3, and controls operation of the brake (in other words, maintains or changes braking on the vehicle 3) during an autonomous drive according to a brake control signal received from the vehicle control unit 38.

The blinker on/off controller is connected to a blinker on/off mechanisms (hereinafter referred to as blinkers; not shown) of the vehicle 3, and controls operation of the blinkers (in other words, turns a blinker on and off to show that the vehicle 3 is turning left or right) during an autonomous drive according to a brake control signal received from the vehicle control unit 38.

The demand adjustment server 4, which is an example server, is configured so as to include a communication interface 41, a memory 42, a processor 43, and a storage 46. The communication interface 41, the memory 42, the processor 43, and the storage 46 are connected to each other so as to be able to exchange data or information via an internal bus.

The communication interface 41 includes a communication circuit capable of exchanging, through a communication, data or information with the external devices (i.e., DM providing server 1, edge servers 2, vehicle 3, and weather information providing server 5) that are connected to the demand adjustment server 4 by the network NW. The communication interface 41 outputs data or information transmitted from each of the above external devices to the memory 42 or the processor 43 and sends data or information that is received from the processor 43 to one of the above external devices. In FIGS. 1 and 7, the communication interface (31 or 41) is abbreviated as “communication I/F” for the sake of convenience, that is, to simplify the figures.

The memory 42 includes a RAM and a ROM, for example, and temporarily holds programs and data that are necessary for operation of the demand adjustment server 4 and data or information generated during its operation. For example, the RAM is a work memory that is used during operation of the demand adjustment server 4. For example, the ROM stores and holds, in advance, programs and data for control of the autonomous drive control device EC1.

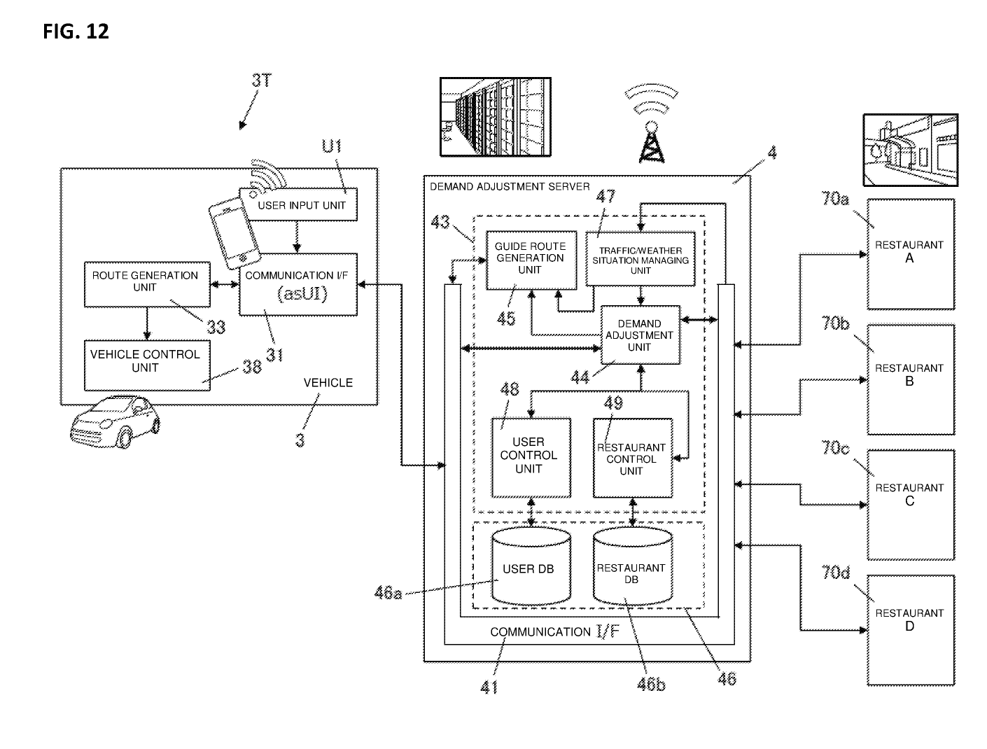

The processor 43 includes a CPU (central processing unit), an MPU (micro-processing unit), a DSP (digital signal processor), or an FPGA (field-programmable gate array). The processor 43, which functions as a control unit of the demand adjustment server 4, performs control processing for supervising operations of the individual units of the demand adjustment server 4, input/output processing for exchanging data with the individual units of the demand adjustment server 4, computation (calculation) processing on data, and data storing processing. The processor 43 operates according to programs and data stored in the memory 42. The processor 43 searches for at least one facility (e.g., restaurant) that satisfies a user demand using various databases (see e.g., FIG. 12) stored in the storage 46 based on demand information received from the vehicle 3. For example, the demand information includes information of a demand relating to an order of the user from a menu of a restaurant, information indicating a destination of the vehicle 3, and position information of the vehicle 3. The processor 43 generates a route (e.g., guide route) to at least one restaurant that has been extracted as a search result, and outputs demand response information (described later) that includes information relating to that restaurant to the communication interface 41.

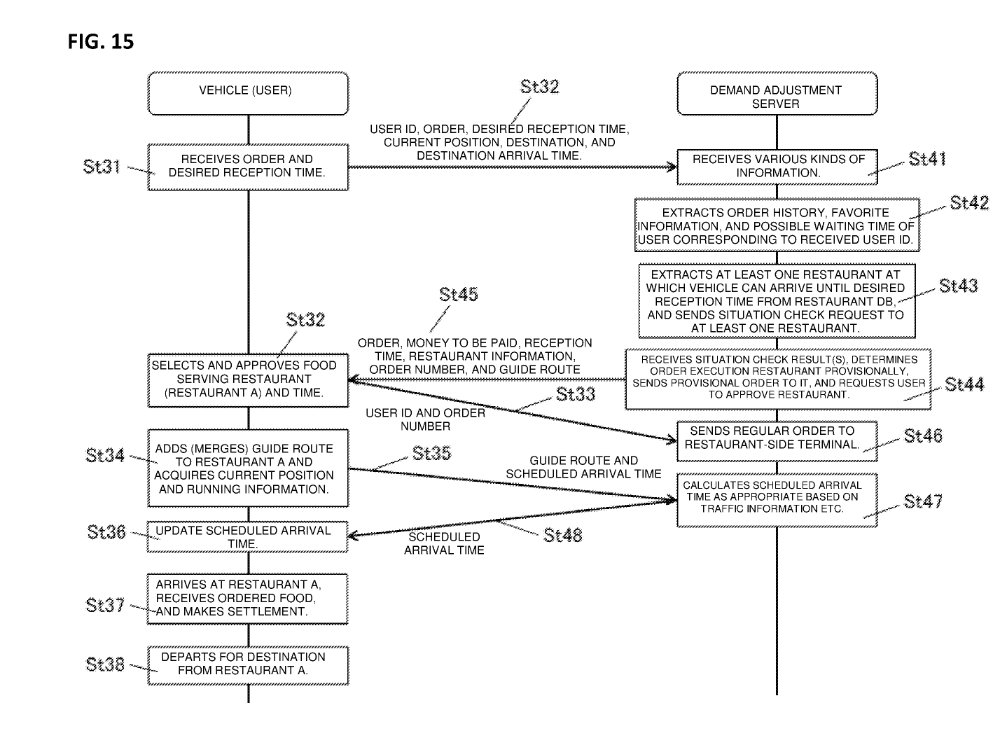

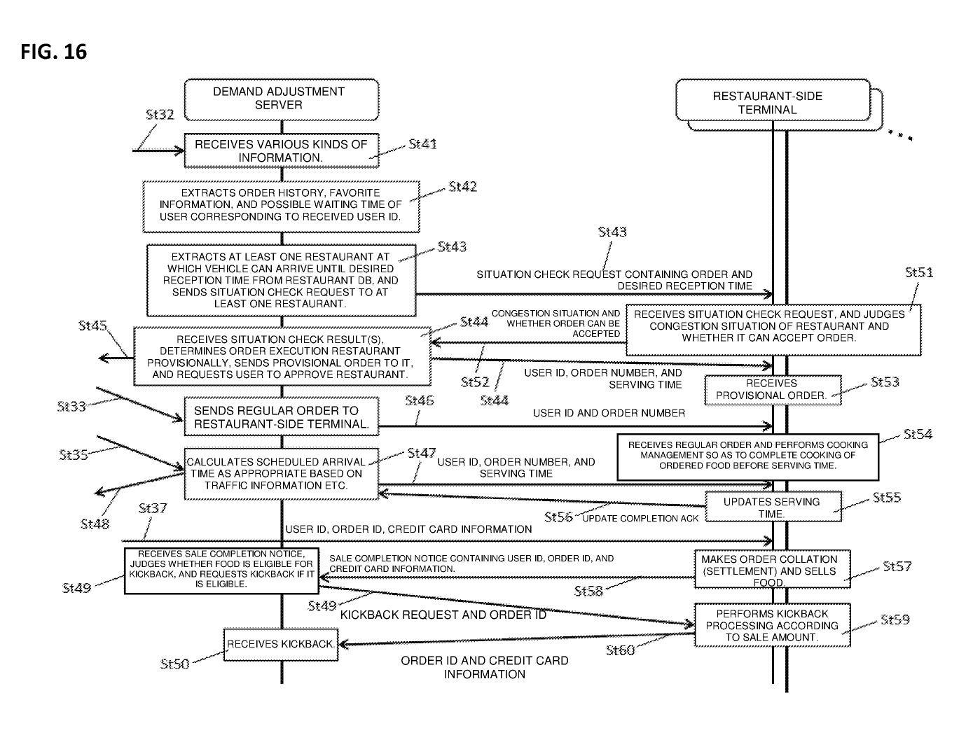

The processor 43 includes, as functional units, a demand adjustment unit 44 and a guide route generation unit 45. A detailed functional configuration of the processor 43 will be described later with reference to FIG. 12. A detailed operation of the processor 43 will be described later with reference to FIGS. 15 and 16.

The demand adjustment unit 44 performs various kinds of adjustment processing between the vehicle 3 and plural restaurant terminals (not shown in FIG. 7; see FIG. 12) that are connected to the demand adjustment server 4 based on demand information corresponding to a demand (e.g., a search for a restaurant to drop in at halfway to a destination) that has been input by a user in the vehicle 3.

Among the various kinds of adjustment processing to be performed by the demand adjustment unit 44 are a search for a restaurant that satisfies a demand of a user, extraction of restaurant information found, and sending-out of an order to a restaurant terminal. For example, if demand information includes a demand of a user that he or she wants to go to a restaurant located within 30 minutes of driving distance, the demand adjustment unit 44 searches for a restaurant located at a position from which the vehicle 3 can reach within 30 minutes, and performs an adjustment, such as inquiring of a restaurant terminal of the respective restaurant whether it can serve ordered food at a time when the vehicle 3 is scheduled to arrive at the restaurant.

The guide route generation unit 45 generates a guide route for guiding the vehicle 3 to a position (e.g., restaurant position) included in restaurant information of at least one restaurant that has been extracted by a restaurant search performed based on demand information corresponding to a demand (e.g., a search for a restaurant to drop in at halfway to a destination) that has been input by a user in the vehicle 3. The guide route generation unit 45 can generate a guide route to the extracted restaurant taking into account a real-time road situation and weather situation by using dynamic map data supplied from the DM providing server 1 and weather information supplied from the weather information providing server 5.

The storage 46 includes a semiconductor memory (e.g., flash memory), an HDD, or an SSD (solid-state drive) incorporated in the demand adjustment server 4 or an external storage medium such as a memory card (e.g., SD card) not incorporated in the demand adjustment server 4. The storage 46 holds data or information generated by the processor 43 and data or information to be used by the processor 43 (see FIG. 12). Where the storage 46 is a memory card, it is set in the body of the demand adjustment server 4 in a detachable manner.

The weather information providing server 5 collects weather information, such as weather, an air temperature, and humidity and performs update etc. on it. The weather information providing server 5 sends the weather information to the vehicle 3 or the demand adjustment server 4 every time it receives a regular request from the vehicle 3 or the demand adjustment server 4.

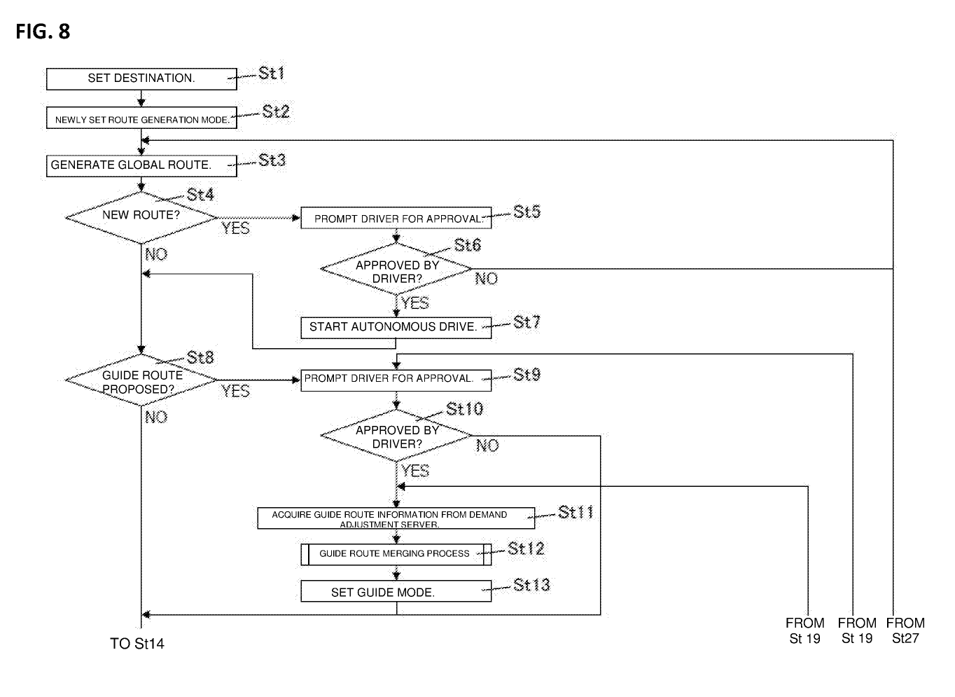

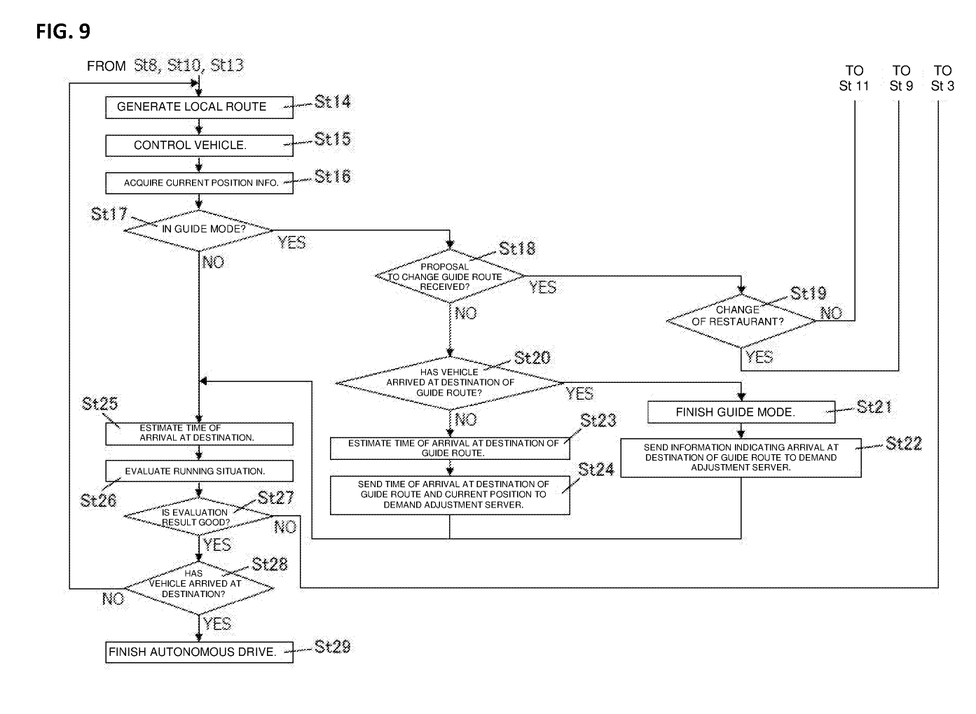

Next, an operation procedure for an autonomous drive of the vehicle 3 according to this aspect of the present disclosure will be described with reference to FIGS. 8 and 9. FIG. 8 is a first part of a flowchart of an example control procedure, for an autonomous drive of the vehicle, of the autonomous drive control device according to the other aspect of the present disclosure. FIG. 9 is a second part of the flowchart of the example control procedure, for an autonomous drive of the vehicle, of the autonomous drive control device according to the other aspect of the present disclosure. FIGS. 8 and 9 are a flowchart of an example control procedure, for an autonomous drive of the vehicle 3, of the autonomous drive control device EC1 according to this aspect of the present disclosure. In the description to be made with reference to FIGS. 8 and 9, it is assumed that the autonomous drive control device EC1 always acquires current position information of the vehicle 3 that is calculated by the GPS receiver, which is an example of a sensor provided on the vehicle 3.

Referring to FIG. 8, at step St1, the user input unit U1 sets a destination of the vehicle 3 in response to manipulations of a user on a destination setting image, screen or picture (not shown) displayed on, for example, an HMI (human machine interface), such as a display of a car navigation device, installed in the vehicle 3. The display of a car navigation device is just an example of the HMI; this aspect of the present disclosure is not limited to this case.

At step St2, the autonomous drive control device EC1 newly sets a route generation mode for generating a route to the destination that was set at step St1. At step St3, the global route generation unit 34 of the route generation unit 33 generates a route from a current position of the vehicle 3 to the destination (i.e., global route). At step St4, the autonomous drive control device EC1 judges whether the route generated at step St3 is a newly generated route. If judging that the route generated at step St3 is not a newly generated route (St4: no), the autonomous drive control device EC1 moves to step St8.

On the other hand, if judging that the route generated at step St3 is a newly generated route (St4: yes), at step St5 the autonomous drive control device EC1 displays a picture, a screen or an image for prompting the user (e.g., driver) to approve the generated route on the HMI (e.g., the display of a car navigation device). If receiving, via the user input unit U1, an approval operation of the user on the image, screen or picture displayed at step St6, at step St7 the autonomous drive control device EC1 causes the vehicle 3 to start an autonomous drive. After the execution of step St7, the autonomous drive control device EC1 moves to step St8. On the other hand, if no user approval operation is made (St6: no), the autonomous drive control device EC1 returns to step St3 to cause the global route generation unit 34 to generate a global route again.

At step St8, the autonomous drive control device EC1 judges whether it has received a proposal of a guide route from the demand adjustment server 4 (i.e., whether the communication interface 31 has received information indicating a restaurant that can be reached along a guide route proposed by the demand adjustment server 4). As described above, after the autonomous drive was start at step St7, the autonomous drive control device EC1 sends demand information (described above) to the demand adjustment server 4 in response manipulations of the user who wants to drop in at a restaurant halfway to the destination. The demand adjustment server 4 sends demand response information (described later) containing information relating to at least one restaurant that satisfies the user demand to the vehicle 3 based on the demand information. If not having received a proposal of a guide route from the demand adjustment server 4 (St8: no), the vehicle 3 continues the current autonomous drive along the route to the destination and hence the autonomous drive control device EC1 moves to step St14.

On the other hand, if the autonomous drive control device EC1 judges that it has received a proposal of a guide route from the demand adjustment server 4 (St8: yes), at step St9 it causes the HMI (e.g., the display of a car navigation device) to display a picture, a screen or an image for prompting the user (e.g., driver) to approve going to a restaurant at which the vehicle 3 can arrive along the proposed guide route. If receiving, via the user input unit U1, an approval operation of the user on the picture, image or screen displayed at step St9 (St10: yes), the autonomous drive control device EC1 sends information indicating approval of the user to the demand adjustment server 4 via the communication interface 31. At step St11, the autonomous drive control device EC1 acquires, via the communication interface 31, information indicating the guide route that is sent from demand adjustment server 4 in response to the information indicating approval of the user.

At step St12, the autonomous drive control device EC1 performs processing of merging the guide route with the route to the destination using the information indicating the guide route acquired at step St11. With this measure, the autonomous drive control device EC1 can properly add, to the route to the destination, a guide route to a restaurant that the user wants to drop in at halfway. Furthermore, since the autonomous drive control device EC1 can, for example, arrange for an order that is directed to a restaurant that satisfies a demand of the user during an autonomous drive to the destination, the user can better utilize time he or she spends in the vehicle 3 during an autonomous drive and hence the convenience of the user can be increased in a proper manner. The guide route merging process will be described with reference to FIGS. 10 and 11.

At step St13, the autonomous drive control device EC1 (more specifically, state managing unit 312) sets, in the memory M1, a mode (hereafter referred to as a “guide mode”) indicating that the user has approved going to the restaurant proposed by the demand adjustment server 4 along the guide route. With this measure, the autonomous drive control device EC1 can properly perform a state management, that is, manage whether at present it is guiding the vehicle 3 to the restaurant proposed by the demand adjustment server 4. On the other hand, if no approval operation is made by the user (St10: no), the autonomous drive control device EC1 moves to step St14 because the vehicle 3 will not drop in at the restaurant proposed by the demand adjustment server 4.

Referring to FIG. 9, at step St14, the local route generation unit 35 of the route generation unit 33 generates a local route for avoiding collision with obstacles (mentioned above) in running along a divisional route between the node corresponding to the current position of the vehicle 3 and the next node. At step St15, the vehicle control unit 38 controls the control target equipment 39 to cause the vehicle 3 to run along the local route generated at step St14. After executing Step St15, at step St16 the autonomous drive control device EC1 acquires information of a current position of the vehicle 3. As described above, the autonomous drive control device EC1 always (i.e., not only at the time point of step St16) acquires information of a current position of the vehicle 3 that is calculated by the GPS receiver.

After executing Step St16, at step St17 the autonomous drive control device EC1 judges whether it is in the guide mode. If judging that it is not in the guide mode (St17: no), the autonomous drive control device EC1 moves to step St25 because the current state is that the vehicle 3 has arrived at the restaurant that satisfies the user demand.

If judging that at present it is in the guide mode (St17: yes), at step St18 the autonomous drive control device EC1 judges whether it has received a proposal for a guide route change from the demand adjustment server 4 (e.g., it has received, via the communication interface 31, information indicating the current restaurant or another restaurant at which the vehicle 3 can arrive along a changed guide route proposed by the demand adjustment server 4 based on a road situation or a weather situation, for example). Step St18 may be executed either when the user requests a change to another guide route in the guide mode or when the demand adjustment server 4 proposes a change to another guide route voluntarily based on a road situation or a weather situation. With this measure, even if a traffic restriction due to, for example, a traffic accident is suddenly applied to the road to, for example, a target restaurant of a guide route, the autonomous drive control device EC1, the autonomous drive control device EC1 can continue an autonomous drive to that restaurant bypassing the location of the traffic restriction properly. Since the autonomous drive control device EC1 can change the guide route to a restaurant dynamically based on real-time monitoring of the traffic situation and the weather situation by the demand adjustment server 4, a waiting time due to a congestion caused by a traffic restriction can be shortened and a user is allowed to spend stress free time while he or she is in the vehicle 3.

If the autonomous drive control device EC1 judges that it has received a proposal to change the guide route from the demand adjustment server 4 (St18: yes), at step St19 it judges whether the target restaurant is changed by the proposal to change the guide route based on information that is sent from the demand adjustment server 4 in connection with the change proposal. For example, the information that is sent from the demand adjustment server 4 in connection with the change proposal includes whether the target restaurant is changed and, if the target restaurant is changed, information relating to a new restaurant. With this measure, the autonomous drive control device EC1 can dynamically change the restaurant to drop in at through close, real-time cooperation between the demand adjustment server 4 and restaurants upon occurrence of, for example, a situation that though a destination of a guide route (restaurant A (described later)) was decided on before it will be difficult for a user to use restaurant A smoothly for a reason on the side of restaurant A. This further increases the convenience of the user.

If judging that the target restaurant is not changed (St19: no), the autonomous drive control device EC1 returns to step St11 because it is appropriate to merge the information of the new restaurant with no approval operation of the user. On the other hand, if judging that the target restaurant is changed (St19: yes), the autonomous drive control device EC1 returns to step St9 because an operation of the user to approve going to the new restaurant is necessary.

On the other hand, if the autonomous drive control device EC1 that judges that it has not received a proposal to change the guide route from the demand adjustment server 4 (St18: no), at step St20 it judges whether the vehicle 3 has arrived at the destination of the guide route (i.e., the restaurant to drop in at) based on information indicating the current position of the vehicle 3. If the autonomous drive control device EC1 judges that the vehicle 3 has arrived at the destination of the guide route (i.e., the restaurant to drop in at) (St20: yes), at step St21 the autonomous drive control device EC1 (more specifically, the state managing unit 312) finishes the guide mode that was set in the memory M1 at step St13. With this measure, the autonomous drive control device EC1 can properly manage a state that a guide to a restaurant that satisfies a user demand has been finished. At step St22, the autonomous drive control device EC1 sends information to the effect that the vehicle 3 has arrived at the destination of the guide route (i.e., the restaurant to drop in at) to the demand adjustment server 4 via the communication interface 31.

On the other hand, if judging that the vehicle 3 has not arrived at the destination of the guide route (i.e., the restaurant to drop in at) yet (St20: no), at step St23 the autonomous drive control device EC1 estimates a time (arrival time) when the vehicle 3 will arrive at the destination of the guide route (i.e., the restaurant to drop in at). At step St 24, the autonomous drive control device EC1 sends, to the demand adjustment server 4, information indicating the estimated arrival time when the vehicle 3 will arrive at the destination of the guide route (i.e., the restaurant to drop in at) and information indicating the current position of the vehicle 3.

At step St25, the autonomous drive control device EC1 estimates time (arrival time) when the vehicle 3 will arrive at the destination that was set at step St1. At step St26, the route evaluation unit 37 of the route generation unit 33 evaluates a running situation of the route to be taken by the vehicle 3 and calculates an evaluation result in the form of a score. At step St27, the route evaluation unit 37 judges whether evaluation result is good. In an example, the evaluation result may be judged to be good when the score calculated at step St26 is larger than or equal to a prescribed threshold value. If the calculated score is smaller than the prescribed threshold value (St27: no), the autonomous drive control device EC1 returns to step St3 because it is necessary to generate an autonomous drive route of the vehicle 3 by the route generation unit 33.

On the other hand, if the route evaluation unit 37 judges that the calculated score is larger than or equal to the prescribed threshold value (St27: yes), at step St28 the autonomous drive control device EC1 judges whether the vehicle 3 has arrived at the destination that was set at step St1. If judging that the vehicle 3 has arrived at the destination (St28: yes), at step St29 the autonomous drive control device EC1 finishes the process because the autonomous drive of the vehicle 3 is to be finished. On the other hand, if judging that the vehicle 3 has not arrived at the destination yet (St28: no), the autonomous drive control device EC1 returns to step St14.

The operation procedure of the guide route merging process (step St12 shown in FIG. 8), which is executed during an autonomous drive of the vehicle 3, will now be described with reference to FIGS. 10 and 11. FIG. 10 is a flowchart showing an example operation procedure of the guide route merging process executed in the vehicle 3 according to this aspect of the present disclosure. FIG. 11 is a diagram illustrating example transitions in a global route that occur during an autonomous drive of the vehicle 3 according to this aspect of the present disclosure. The operation shown in FIG. 10 is mainly performed by the guide route merging unit 36. In FIG. 11, a route R0 is a route (global route) that is generated as a result of execution of step St3 and leads from a present position of the vehicle 3 to a destination.

Referring to FIG. 10, at step St12-1, the guide route merging unit 36 acquires information indicating a present position of the vehicle 3, which is always acquired by the vehicle 3. At step St12-2, the guide route merging unit 36 employs the present position of the vehicle 3 acquired at step St12-1 as a guide route upstream end and acquires N nodes ND1, ND2, ND3, ND4, ND(N−2), ND(N−1), and NDN (N: integer that is larger than or equal to 2) from plural (larger than or equal to N+1) nodes constituting the route from the guide route upstream end to the destination. At step St12-3, the guide route merging unit 36 calculates distances between the present position of the vehicle 3 acquired at step St12-1 and the N respective nodes acquired at step St12-2.

At step St12-4, the guide route merging unit 36 selects a node (i.e., node ND1) whose distance is shortest among the distances calculated at step St12-3 as a connection point, which is a connection point of the global route (route R0) generated at step St3 and a guide route and hence is a start point of the guide route.

At step St12-5, the guide route merging unit 36 generates a route R1 that leads from the present position to the connection point (node ND1). At step St12-6, the guide route merging unit 36 extracts, that is, cuts out, a route R2 that leads from the guide route connection point selected at step St12-4 to its most downstream point (e.g., restaurant A as a guide route destination; see FIG. 11) from the guide route based on information indicating the guide route that was sent from the demand adjustment server 4. In other words, the guide route merging unit 36 corrects the connection point (start point) of the guide route and generates a guide route that leads from the corrected start point to restaurant A.

The guide route merging unit 36 does not use the information itself indicating the guide route that was sent from the demand adjustment server 4 at step St11, for the following reason. Specifically, the vehicle 3 is moving after starting an autonomous drive at step St7. That is, a certain time has elapsed from the time point when the information relating to the guide route was received from the demand adjustment server 4 at step St11 to the time point when the guide route merging unit 36 executes step St12-6. In this period, the vehicle 3 advances as it performs an autonomous drive. As a result, there is a deviation from the start point of the guide route indicated by the guide route information sent from the demand adjustment server 4. Thus, the guide route merging unit 36 generates the guide route (guide route R2) after setting, at steps St12-4, St12-5, and St12-6, the corrected connection point that corresponds to the start point of an actual guide route for the vehicle 3.

At step St12-7, the guide route merging unit 36 generates a route R3 from the most downstream point (restaurant A as the guide route destination; see FIG. 11) to the destination. At step St12-8, the guide route merging unit 36 connects together the routes R1, R2, and R3 that were generated at the respective steps St12-5, St12-6, and St12-7 and sets a resulting route as a global route (i.e., a route after the merging of the guide route). With this measure, the guide route merging unit 36 can re-set a route by incorporating (merging), into (with) a route to a destination, a guide route (route R2) for guiding the vehicle 3 to a restaurant (e.g., restaurant A) that satisfies a user demand in response to a simple operation (e.g., an approval operation made at step St9) of a user during an autonomous drive to a destination of the vehicle 3.

FIG. 12 is a block diagram showing an example configuration of the demand adjustment system 1000 that is centered by the demand adjustment server 4 according to this aspect of the present disclosure. Units etc. having the same ones in the demand adjustment system 1000 shown in FIG. 7 will be given the same symbols as the latter and descriptions therefor will be simplified or omitted; only differences will be described. Although both of FIGS. 7 and 12 are block diagrams showing example configurations of the same demand adjustment system 1000 according to this aspect of the present disclosure, FIG. 7 shows an aspect, relating to an autonomous drive and centered by the vehicle 3, of the demand adjustment system 1000, whereas FIG. 12 shows an aspect, relating to adjustment with a restaurant and centered by the demand adjustment server 4, of the demand adjustment system 1000.

The vehicle 3 shown in FIG. 12 includes at least the user input unit U1, the communication interface 31, the route generation unit 33, and the vehicle control unit 38. The configuration of the vehicle 3 is shown in a simplified manner in FIG. 12 and in a detailed manner in FIG. 7. The user input unit U1, the communication interface 31, the route generation unit 33, and the vehicle control unit 38 have been described above with reference to FIG. 7 and hence will not be described here. Where a user has a smartphone 3T as shown in FIG. 12, the smartphone 3T may be used to serve as the user input unit U1 and the communication interface 31 of the vehicle 3.

The demand adjustment server 4 shown in FIG. 12 is connected to terminals (hereinafter referred to as “restaurant-side terminals”) installed in plural respective facilities (restaurants in this example), so as to be able to communicate with the latter. Each restaurant-side terminal may have the configuration shown in FIG. 3 or 4. Communication between the demand adjustment server 4 and each of the plural restaurant-side terminals 70a, 70b, 70c, and 70d may be performed by either wired communication or wireless communication. Although in FIG. 12 the restaurant-side terminals 70a, 70b, 70c, and 70d, which correspond to four respective restaurants A, B, C, and D, are connected to the demand adjustment server 4. It goes without saying that the restaurant-side terminals connected to the demand adjustment server 4 are not limited to the restaurant-side terminals 70a, 70b, 70c, and 70d shown in FIG. 12.

The demand adjustment server 4 shown in FIG. 12 is configured to include at least the communication interface 41, the processor 43, and the storage 46. A detailed functional configuration that is implemented by the processor 43 is shown in FIG. 12. More specifically, the demand adjustment unit 44, the guide route generation unit 45, a traffic/weather situation managing unit 47, a user control unit 48, and a restaurant control unit 49 and processes executed by these respective units can be realized through cooperation between the processor 43 and the memory 42 (see FIG. 7). The demand adjustment unit 44 and the guide route generation unit 45 have already been described above with reference to FIG. 7 and hence will not be described here again.

The traffic/weather situation managing unit 47 performs management, such as always receiving dynamic map data supplied from the DM providing server 1 (see FIG. 7) and weather information supplied from the weather information providing server 5 and storing them in the storage 46. The traffic/weather situation managing unit 47 outputs received dynamic map data and weather information to the guide route generation unit 45. The dynamic map data and weather information are referred to when they are necessary in generating a guide route to be proposed to, for example, a vehicle (may be the vehicle 3) that performs an autonomous drive.

The user control unit 48 accesses a user database 46a and manages (e.g., extracts, newly registers, updates, and deletes) information relating to users who are registered as users of the demand adjustment system 1000.

The restaurant control unit 49 accesses a restaurant database 46b and manages (e.g., extracts, newly registers, updates, and deletes) information relating to the restaurants corresponding to the plural respective restaurant-side terminals 70a, 70b, 70c, and 70d, which are connected to the demand adjustment server 4 so as to be able to communicate with it.

Specifically, the storage 46 includes the user database 46a and the restaurant database 46b. In FIG. 12, the user database 46a and the restaurant database 46b are abbreviated as “user DB” and “restaurant DB” for the sake of convenience, that is, to simplify the figure.

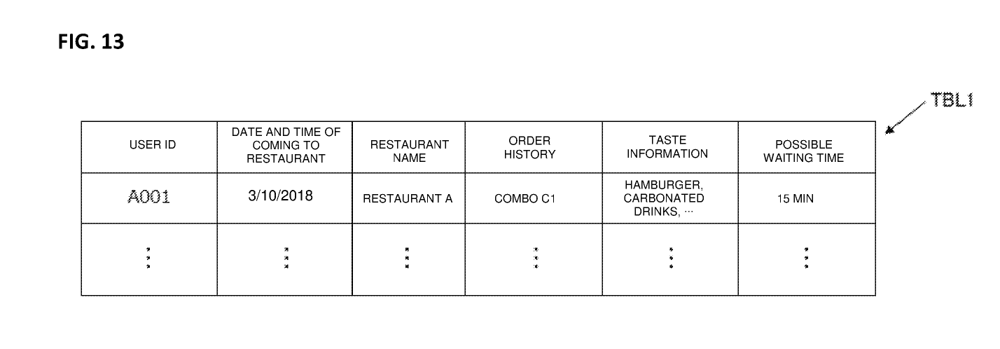

The user database 46a is formed using an RDB (relational database), for example, and holds information relating to users who are registered as users of the demand adjustment system 1000 (see FIG. 13). FIG. 13 shows an example structure of user data that are registered in the user database 46a.

As shown in FIG. 13, the user database 46a is stored with user data TBL1, which is a combination of pieces of one-record user information of respective users. Each piece of user information is information in which a date and time of coming to a restaurant, a name of the restaurant, an order history, taste information (i.e., information indicating food preferences of the user), and a possible waiting time for which the user would not feel stress are correlated with a user ID (user identification information). For example, it is seen from the user information corresponding to the user ID “A001” that the user came to restaurant A on Mar. 10, 2018 and ordered “combo C1,” and also that the user could wait for reception of food ordered from, for example, a drive-through for 15 minutes (possible waiting time).

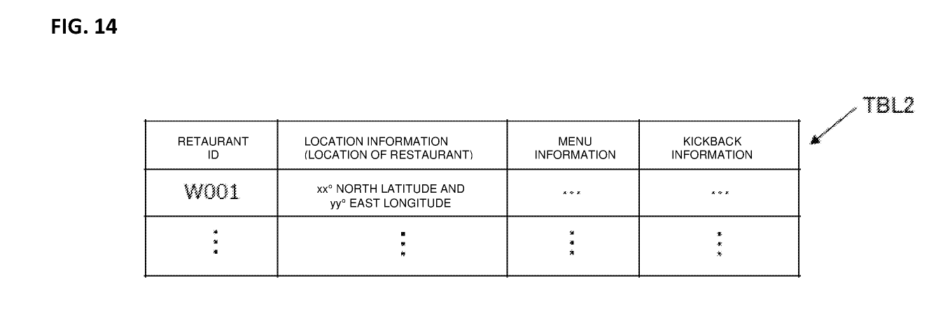

The restaurant database 46b is formed using an RDB, for example, and holds information relating to plural restaurants that are registered as facilities to be used by the demand adjustment system 1000 (see FIG. 14). FIG. 14 shows an example structure of restaurant data that are registered in the restaurant database 46b.

As shown in FIG. 14, the restaurant database 46b is stored with restaurant data TBL2 which is a combination of pieces of one-record restaurant information of respective restaurants. Each piece of restaurant information is information in which location information indicating a location of the restaurant, menu information indicating foods (and drinks) that the restaurant can provide for a customer (e.g., user), information indicating foods (and drinks) selected by the restaurant identified as kickbacks, and parking information are correlated with a restaurant ID (restaurant identification information) and also identified as kickbacks. The parking information indicates the availability of a parking lot that is owned by the restaurant or allowed to be used by customers according to a contract with its owner, for example. The availability of a parking lot may be either information simply indicating presence/absence of an empty parking space(s) or quantitative (i.e., specific) information indicating the number of empty parking spaces. For example, it is seen from the restaurant information corresponding to the restaurant having a restaurant ID “W001” that restaurant is located at xx° north latitude and yy° east longitude. The restaurant information also indicates a menu, the availability etc. of a parking lot, foods ((and drinks) as kickbacks.

The restaurant-side terminal 70a is formed using a PC (personal computer), for example, and connected to the demand adjustment server 4 so as to be able to communicate with it. The restaurant-side terminal 70a performs various kinds of management processing in restaurant A. For example, when receiving an order from the demand adjustment server 4, the restaurant-side terminal 70a issues cooking instructions for foods (and drinks) included in the order to various managing devices disposed at respective places (e.g., in a hall or kitchen) of restaurant A. Always having data indicating a congestion situation of restaurant A while it is open, the restaurant-side terminal 70a judges whether it can respond positively to an inquiry as to whether restaurant A can provide ordered food at a time specified by the demand adjustment server 4 and sends a judgment result back to the demand adjustment server 4.

The restaurant-side terminal 70b is formed using a PC, for example, and connected to the demand adjustment server 4 so as to be able to communicate with it. The restaurant-side terminal 70b performs various kinds of management processing in restaurant B. For example, when receiving an order from the demand adjustment server 4, the restaurant-side terminal 70b issues cooking instructions for foods (and drinks) included in the order to various managing devices disposed at respective places (e.g., in a hall or kitchen) of restaurant B. Always having data indicating a congestion situation of restaurant B while it is open, the restaurant-side terminal 70b judges whether it can respond positively to an inquiry as to whether restaurant B can provide ordered food at a time specified by the demand adjustment server 4 and sends back, to the demand adjustment server 4, a judgment result and parking lot information indicating the availability of the parking lot including predicted availability at the above-mentioned specified time.

The restaurant-side terminal 70c is formed using a PC, for example, and connected to the demand adjustment server 4 so as to be able to communicate with it. The restaurant-side terminal 70c performs various kinds of management processing in restaurant C. For example, when receiving an order from the demand adjustment server 4, the restaurant-side terminal 70c issues cooking instructions for foods (and drinks) included in the order to various managing devices disposed at respective places (e.g., in a hall or kitchen) of restaurant C. Always having data indicating a congestion situation of restaurant C while it is open, the restaurant-side terminal 70c judges whether it can respond positively to an inquiry as to whether restaurant C can provide ordered food at a time specified by the demand adjustment server 4 and sends a judgment result back to the demand adjustment server 4.

The restaurant-side terminal 70d is formed using a PC, for example, and connected to the demand adjustment server 4 so as to be able to communicate with it. The restaurant-side terminal 70d performs various kinds of management processing in restaurant D. For example, when receiving an order from the demand adjustment server 4, the restaurant-side terminal 70d issues cooking instructions for foods (and drinks) included in the order to various managing devices disposed at respective places (e.g., in a hall or kitchen) of restaurant D. Always having data indicating a congestion situation of restaurant D while it is open, the restaurant-side terminal 70d judges whether it can respond positively to an inquiry as to whether restaurant D can provide ordered food at a time specified by the demand adjustment server 4 and sends a judgment result back to the demand adjustment server 4.

Next, the procedure of operations relating to demand adjustment performed by the demand adjustment system 1000 according to this aspect of the present disclosure, such as a search for a restaurant that satisfies a user demand and issuance of an order to the restaurant, will be described with reference to FIGS. 15 and 16. FIG. 15 is a sequence diagram showing part of an example operation procedure of demand adjustment performed by the demand adjustment system according to the other aspect of the present disclosure. FIG. 16 is a sequence diagram showing the remaining part of the example operation procedure of the demand adjustment performed by the demand adjustment system according to the other aspect of the present disclosure. More specifically, FIGS. 15 and 16 are sequence diagrams showing an example operation procedure of demand adjustment performed by the demand adjustment system 1000 according to this aspect of the present disclosure. The sequence diagram of FIG. 15 consists of a flowchart showing a time-series operation procedure of the vehicle 3 and a flowchart showing a time-series operation procedure of the demand adjustment server 4. The sequence diagram of FIG. 16 consists of a flowchart showing a time-series operation procedure of the demand adjustment server 4 and a flowchart showing a time-series operation procedure of one of the plural restaurant terminals. The description to be made below with reference to FIGS. 15 and 16 assumes that the vehicle 3 is doing an autonomous drive to a destination that has been set in response to a user manipulation.

Referring to FIGS. 15 and 16, at step St31, the vehicle 3 receives an order of food desired by a user (e.g., an order of food (and a drink) that can be provided by a drive-through) and its desired reception time that are input by the user by manipulating the user input unit U1 during an autonomous drive to, for example, effectively utilize, taking food, time he or she will spend until reaching a destination. At step St32, the vehicle 3 sends, to the demand adjustment server 4, demand information including a user ID (user identification information), the order and the desired reception time that were received at step St31, a current position of the vehicle 3 and a destination, and a destination arrival time that was calculated when the destination was set.

At step St41, the demand adjustment server 4 receives the various kinds of information that were sent from the vehicle 3 at step St 32. At step St42, the demand adjustment server 4 extracts a past order history, favorite information, and a possible waiting time of the user corresponding to the user ID received at step St41 by referring to the user database 46a (see FIG. 13).

At step St43, the demand adjustment server 4 extracts information relating to at least one restaurant at which the vehicle 3 can arrive until the desired reception time received at step St41 by referring to the restaurant database 46b. Also at step St43, the demand adjustment server 4 sends a request for checking a congestion situation in a prescribed period (e.g., from 5 minutes before the desired reception time to 5 minutes after that) to each restaurant-side terminal (e.g., restaurant-side terminal 70a) corresponding to the at least one extracted restaurant (e.g., restaurant A). The congestion situation check request contains the order of the user and the desired reception time.

At step St51, the restaurant-side terminal (e.g., restaurant-side terminal 70a) receives the congestion situation check request that was sent at step St43. Holding data (not shown) indicating a congestion situation of the corresponding restaurant, also at step St51 the restaurant-side terminal judges, based on that data, a congestion situation in a period (e.g., from 5 minutes before the desired reception time to 5 minutes after that) and whether cooking of the ordered food and other work will be finished before the desired reception time (i.e., whether the order including the desired reception time can be accepted). At step St52, the restaurant-side terminal sends back the judgment results made at step St51 (i.e., congestion situation and whether the order can be accepted) to the demand adjustment server 4.

At step St44, the demand adjustment server 4 receives the judgment results (i.e., the congestion situation in the period (e.g., from 5 minutes before the desired reception time to 5 minutes after that) and whether the order can be accepted) from each restaurant-side terminal. Also at step St44, the demand adjustment server 4 determines, provisionally, a restaurant (order execution restaurant) that satisfies the user demand (i.e., can execute the order) based on check results sent form the respective restaurants, with higher priority given to a restaurant that will not be congested in the time slot of the desired reception time and hence can provide the ordered food quickly for the user. Furthermore, at step St44, the demand adjustment server 4 sends, to that restaurant, a provisional order instruction containing the user ID, an order number, and a serving time (i.e., desired reception time). And the demand adjustment server 4 generates a guide route for guiding the vehicle 3 to the restaurant based on the current position information received at step St41 and the information indicating the position of the provisionally determined restaurant.

When receiving, at step St53, the provisional order instruction that is sent from the demand adjustment server 4 at step St44, the restaurant-side terminal (e.g., restaurant-side terminal 70a) waits for reception of a regular order instruction from the demand adjustment server 4.

Still at step St44, the demand adjustment server 4 generates a picture, image or screen (not shown) for prompting the user to approve the provisionally determined restaurant and sends demand response information (in other words, a request for user approval) containing data of the generated picture, image or screen. More specifically, the demand adjustment server 4 sends, to the vehicle 3, as demand response information (denoted by symbol St45 in FIG. 15), the order, a corresponding money to be paid, the reception time, information indicating the provisionally determined restaurant, a provisional order number, various kinds of information including a guide route, and the data of the picture, image or screen for prompting the user to approve the provisionally determined restaurant.

The vehicle 3 receives the demand response information that was sent from the demand adjustment server 4 at step St45, and displays the picture, image or screen for prompting the user to approve the provisionally determined restaurant on the HMI (not shown) installed in the vehicle 3. At step St32, the vehicle 3 selects and approves the restaurant that satisfies his or her demand (in other words, the restaurant to receive the ordered food) and the time to receive the food by manipulating the user input terminal U1. At step St33, the vehicle 3 transmits, to the demand adjustment server 4, the selection and approval information, and the time information for receiving food of step St32. In the following description, the restaurant that has been selected and approved by the user will be referred to as “restaurant A.”

At step St32, instead of displaying the picture, image or screen for prompting the user to approve the provisionally determined restaurant on the HMI (not shown) installed in the vehicle 3, the vehicle 3 may transfer the picture/image/screen data to a smartphone 3T owned by the user via the communication interface 31 and a cellphone network (not shown). With this measure, the vehicle 3 can cause the display of the smartphone 3T to display the picture, image or screen for prompting the user to approve the provisionally determined restaurant. In this case, the restaurant (restaurant A) that satisfies the user demand is selected and approved by manipulating the smartphone 3T and the information relating to that restaurant is transferred from the smartphone 3T to the vehicle 3.

If the restaurant (restaurant A) that satisfies the user demand is selected and approved at step St32, at step St33 the vehicle 3 sends, to the demand adjustment server 4, the information relating to the selected and approved restaurant (restaurant A) and the user ID and the order number that were contained in the demand response information.

At Step St46, the demand adjustment server 4 sends a regular order instruction (e.g., order data) to the restaurant-side terminal (restaurant-side terminal 70a) of the restaurant (restaurant A) selected and approved by the user based on the various kinds of information that were sent from the vehicle 3 at step St33, that is, using the user ID and the order number. In sending the regular order instruction (order data), the demand adjustment server 4 sends the same user ID and order number as it sent at step St44 together with the serving time.

At step St54, the restaurant-side terminal (e.g., restaurant-side terminal 70a) receives the regular order instruction that was sent from the demand adjustment server 4 at step St46 and performs cooking management so as to complete cooking of the ordered food before the serving time.

At step St34, the vehicle 3 executes the process (see FIG. 10) of adding (merging) a guide route to restaurant A that were selected and approved at step St33 to (with) the route to the destination using the guide route information that was sent from the demand adjustment server 4 at step St45. Also at step St34, after merging the guide route, the vehicle 3 acquires information indicating a current position and running information and calculates a scheduled time of arrival at restaurant A based on the current position and the running information. At step St35, the vehicle 3 sends, to the demand adjustment server 4, information indicating the guide route merged by the guide route merging unit 36 and information indicating the calculated scheduled time of arrival at restaurant A to the demand adjustment server 4.

At step St47, the demand adjustment server 4 updates the scheduled time of arrival at restaurant A by performing a calculation as appropriate based on the information indicating the guide route and the scheduled arrival time that were sent from the vehicle 3 at step St35 taking into consideration traffic information, weather information, etc. for the guide route. At step St48, the demand adjustment server 4 sends information indicating the scheduled arrival time at restaurant A as updated at step ST47 to the vehicle 3. At step S47, the demand adjustment server 4 sends the same information to the restaurant-side terminal 70a of restaurant A. In doing so, it is preferable that the demand adjustment server 4 also send information indicating the updated schedule arrival time (in other words, updated serving time) corresponding to the user ID and the order number to the restaurant-side terminal 70a of restaurant A.

Upon receiving the information indicating the updated serving time sent from the demand adjustment server 4 at step St47, at step St55 the restaurant-side terminal 70a of restaurant A updates the serving time that was sent from the demand adjustment server 4 at step St44 to the received serving time. At step St56, the restaurant-side terminal 70a of restaurant A sends an update completion ACK (acknowledgment) to the effect that the serving time has been updated (at step St55) to the demand adjustment server 4. With this measure, the demand adjustment server 4 can properly recognize that the serving time as updated by the addition of the guide route has been received by the restaurant-side terminal 70a of restaurant A.

At step St36, the vehicle 3 updates the scheduled arrival time that was calculated by itself at step St34 to the scheduled time of arrival at restaurant A that was sent from the demand adjustment server 4 at step St48. With this measure, the vehicle 3 can set a scheduled time of arrival at restaurant A that reflects information about a traffic situation and weather situation that may vary in real time, and hence can inform the user of a more correct scheduled time of arrival at restaurant A and thereby increase the convenience of the user.

When the vehicle 3 arrives at restaurant A, at step St37 the user receives ordered food from a worker of restaurant A and makes necessary settlement. Also at step St37, the vehicle 3 or the smartphone 3T owned by the user sends various kinds of information (e.g., credit card information) including a credit card number that is input by the user, the user ID, and an order ID to the restaurant-side terminal 70a of restaurant A directly or via the demand adjustment server 4. The order ID is an ID for identification of credit card payment of an amount charged corresponding to the order number and may be either the same as or different from the order number.

At step St57, the restaurant-side terminal 70a of restaurant A receives the user ID, the order ID, and the credit card information that were sent from the vehicle 3 or the smartphone 3T at step St37, collates these pieces of information with the details of the order, and makes settlement (in other words, sells the food etc. being served). At step St58, the restaurant-side terminal 70a of restaurant A generates a sale completion notice containing the user ID, the order ID, and the credit card information and sends it to the demand adjustment server 4.

At step St49, the demand adjustment server 4 receives the sale completion notice that was sent from the restaurant-side terminal 70a of restaurant A at step St58. Also at step St49, the demand adjustment server 4 refers to a table that correlates kinds of food on menus with presence/absence of kickback, and judges whether the food corresponding to the sale completion notice is eligible for kickback. Still at step St49, if judging that the food is eligible for kickback, the demand adjustment server 4 generates a kickback request containing the order ID and sends it to the restaurant-side terminal 70a of restaurant A.

At step St59, the restaurant-side terminal 70a of restaurant A performs kickback processing (e.g., sending of an amount of money of the kickback) according to an amount of money (sale amount) of the settlement that was made at step St57. After performing the kickback processing, at step St60 the restaurant-side terminal 70a of restaurant A generates a kickback completion notice containing the order ID and the credit card information and sends it to the demand adjustment server 4.

At step St50, the demand adjustment server 4 receives the kickback completion notice that was sent from the restaurant-side terminal 70a of restaurant A at step St60. With this measure, a company that operates the demand adjustment server 4 can receive a proper profit margin for the adjustment of advance ordering of food and other processing between the vehicle 3 which is an autonomous vehicle and restaurant A which is a drive-through restaurant, for example.

After executing step St37, at step St38 the vehicle 3 departs for the destination from restaurant A and starts an autonomous drive.

In the above-described demand adjustment system 1000 according to this aspect of the present disclosure, the autonomous drive control device EC1 is installed in the vehicle 3 which is connected to the demand adjustment server 4 so as to be able to communicate with it. In the autonomous drive control device EC1, the route generation unit 33 generates a route to a destination and the vehicle control unit 38 controls an autonomous drive of the vehicle 3 to the destination based on information indicating the route to the destination. In response to a user's operation for inputting a demand relating to an order, the reception unit 311 of the autonomous drive control device EC1 receives information sent from the demand adjustment server 4 and indicating a guide route to a facility (e.g., restaurant A) that satisfies the demand. In response to the user's operation for approving restaurant A, the autonomous drive control device EC1 generates information indicating a new route to the destination by merging the route to restaurant A with the route to the destination.

According to the above procedure, when a user wants to drop in at and use a restaurant such as a drive-through during an autonomous drive of the vehicle 3 to a destination, the autonomous drive control device EC1 or the vehicle 3 can change, adaptively, in response to a simple user operation (e.g., approval manipulation), a route to the destination including selection from drive-through restaurants and a change of a restaurant during a drive along a guide route. Since the user can order food from the drive-through restaurant in advance, that is, before the vehicle 3 arrives at it, the user can receive the ordered food when the vehicle arrives at the restaurant. In this manner, the autonomous drive control device EC1 or the vehicle 3 allows the user to effectively utilize time he or she spends during the autonomous drive and thereby increases the convenience of the user in a proper manner.

In the autonomous drive control device EC1, the environment recognition unit 32 of recognizes a surrounding environment including a position of the vehicle 3 based on detection outputs of the plural sensors S1-Sk of the vehicle 3 and the route generation unit 33 generates a route to a destination based on information about the recognized surrounding environment. With this measure, the autonomous drive control device EC1 or the vehicle 3 can generate a proper route taking a surrounding environment of the vehicle 3 into consideration and hence enables a safe autonomous drive to a destination of the vehicle 3.

When a guide route (e.g., a route to restaurant A selected by a user approval manipulation) is merged with a route to a destination, the state managing unit 312 of the autonomous drive control device EC1 sets a guide mode indicating a state that the vehicle 3 is guided to restaurant A. With this measure, the autonomous drive control device EC1 or the vehicle 3 can properly perform a state management as to whether at present the vehicle 3 is being guided to restaurant A which satisfies a user demand.

When the vehicle 3 arrives at restaurant A, the state managing unit 312 of the autonomous drive control device EC1 sets the end of a guide mode. With this measure, the autonomous drive control device EC1 or the vehicle 3 can properly manage a state that a guide of the vehicle 3 to restaurant A that satisfies a user demand has finished.

When receiving information indicating a new guide route (second guide route) reflecting a change to a current guide route to restaurant A from the demand adjustment server 4 in a guide mode, generates a new route to a destination by merging the new guide route with a current route to the destination. With this measure, even if, for example, a traffic restriction occurs suddenly on a road that is part of a route to restaurant A due to a traffic accident or the like, the autonomous drive control device EC1 or the vehicle 3 allows an autonomous drive to restaurant A to continue bypassing the location of the traffic restriction. In this manner, the autonomous drive control device EC1 or the vehicle 3 can dynamically change a guide route to restaurant A based on real-time monitoring of a traffic situation and a weather situation that is performed by the demand adjustment server 4. This makes it possible to shorten a waiting time due to a congestion caused by a traffic restriction and allow a user is allowed to spend, stress free, time he or she is in the vehicle 3.

When receiving information indicating a new guide route (third guide route) to restaurant B (another facility) that is different from restaurant A in a guide mode, the autonomous drive control device EC1 generates a new route to a destination by merging the new guide route with a current route to the destination in response to a user operation for approving restaurant B. With this measure, upon occurrence of a situation that restaurant A was determined as a restaurant at which a user is to drop in but has been rendered unable to smoothly serve for the user when he or she will arrive at it due to a reason on the side of it, the autonomous drive control device EC1 or the vehicle 3 can dynamically change the restaurant at which the user is to drop in through real-time close inter-system cooperation between the demand adjustment server 4 and restaurants. This further increases the convenience of a user.

In the demand adjustment system 1000 according to this aspect of the present disclosure, the vehicle 3 including the autonomous drive control device EC1 for controlling an autonomous drive and the demand adjustment server 4 are connected to each other so as to be communicate with each other. During an autonomous drive to a destination, the vehicle 3 sends, to the demand adjustment server 4, demand information containing destination information and vehicle position information to the demand adjustment server 4 in response to user manipulations for inputting a demand relating to his or her order. Based on the demand information sent from the vehicle 3, the demand adjustment server 4 searches for at least one facility (e.g., restaurant A) that satisfies the user demand and sends, to the vehicle 3, information indicating a guide route from a current position of the vehicle 3 to restaurant A and information relating to restaurant A. The vehicle 3 acquires the information indicating the guide route and the information relating to restaurant A that are sent from the demand adjustment server 4, and generates a new route to the destination by merging the guide route with a current route to the destination in response to a user operation for approving restaurant A.

According to the above procedure, in the demand adjustment system 1000, when a user wants to drop in at and use a restaurant such as a drive-through restaurant during an autonomous drive to a destination of the vehicle 3, the route to the destination, including the drive-through restaurant, can be changed adaptively in response to a simple operation (e.g., approval manipulation) of the user. Thus, the user can place an order with the drive-through restaurant before the vehicle 3 arrives at it. It is expected that the user can receive ordered food as soon as arriving at the restaurant. As such, the autonomous drive control device EC1 or the vehicle 3 allows a user to effectively utilize time he or she spends in the vehicle 3 that is making an autonomous drive and hence can increase the convenience of the user in a proper manner.

Although the various embodiments have been described with reference to the drawings, it goes without saying that the present disclosure is not limited to those embodiments. It is apparent that those skilled in the art can conceive various modifications, corrections, replacements, additions, deletions, and equivalents within the confines of the claims, and they should be considered belonging to the technical scope of the present disclosure. Furthermore, elements of different ones of the above embodiments may be combined together in a desired manner without departing from the spirit and scope of the invention.

In the above embodiment, after merging a guide route generated by, for example, the demand adjustment server 4 with a route to a destination of the vehicle 3, the autonomous drive control device EC1 or the vehicle 3 may generate a new guide route by changing the current guide route dynamically according to, for example, a traffic situation on the road on which the vehicle 3 is running. In this case, after the merging of the guide route and in a guide mode in which the vehicle 3 is being guided to a facility (e.g., restaurant A), the autonomous drive control device EC1 or the vehicle 3 generates a new guide route by changing the current guide route dynamically based on detection information (in other words, information indicating an environment surrounding the vehicle 3) of the sensors S1-Sm. The autonomous drive control device EC1 or the vehicle 3 sends (in other words, feeds back) the information indicating the new guide route to the demand adjustment server 4 over the network NW. When receiving the information indicating the new guide route sent from the vehicle 3, the demand adjustment server 4 calculates a new scheduled arrival time when the vehicle 3 will arrive at restaurant A (from which food was ordered by a user of the vehicle 3) by running along the new guide route and informs the restaurant-side terminal 70a of the new scheduled arrival time.

According to the above procedure, the vehicle 3 can minimize a delay of arrival at restaurant A by, for example, changing the guide route to restaurant A (e.g., to a bypass route) according to information indicating an environment surrounding the vehicle 3 (e.g., information that lane construction is being carried out on the road on which the vehicle 3 is running). According to the feedback information from the vehicle 3, the demand adjustment server 4 informs restaurant A (from which the food was ordered) of the change of the scheduled arrival time of the vehicle 3 and the new scheduled arrival time. Restaurant A is thus given the latest information, whereby the convenience of the user can be increased.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in the particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although the specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to the one aspect of the present disclosure, a method is provided for synchronizing operations of an autonomous vehicle (AV) and a restaurant system of a restaurant. The method includes receiving, on a user interface of the AV, an order submitted to the restaurant system of the restaurant; obtaining initial vehicle data of the AV based on a location of the restaurant, the initial vehicle data including estimated time of arrival (ETA) at the restaurant; transmitting, to the restaurant system, order data of the order and the initial vehicle data; extracting, from a memory of the restaurant system, at least one food preparation/delivery (FPD) template corresponding to the order data; generating, using a processor of the restaurant system, at least one FPD process for execution by at least one resource of the restaurant system based on the order data and the extracted at least one FPD template; generating, by the restaurant system, at least one scheduled instruction to the at least one resource of the restaurant for executing the at least one FPD process; determining, based on progress status of the at least one FPD process being executed, an estimated order completion time for the order; and controlling the AV and the restaurant system to minimize a difference between the ETA and the estimated order completion time.

According to another mode of the present disclosure, the method further includes monitoring a progress status of the at least one FPD process; determining whether a revision of the at least one FPD process is warranted based on the progress status of the at least one FPD process; and when the revision of the at least one FPD process is determined to be warranted, revising the schedule instruction based on the revised at least one FPD process.

According to yet another mode of the present disclosure, the determining of whether a revision of the at least one FPD process is warranted is performed at predetermined intervals.

According to still another mode of the present disclosure, the determining of whether a revision of the at least one FPD process is warranted when an event is detected.

According to another mode of the present disclosure, the method further includes extracting, from the memory, a restaurant preference, in which the at least one scheduled instruction is generated in accordance with the restaurant preference.

According to yet another mode of the present disclosure, the method further includes generating, by the AV, updated vehicle data of the AV; and transmitting, to the restaurant system, the updated vehicle data of the AV.

According to still another mode of the present disclosure, the updated vehicle data of the AV is generated at predetermined intervals.

According to another mode of the present disclosure, the updated vehicle data of the AV is generated in response to detection of an incident.

According to yet another mode of the present disclosure, the controlling includes modifying an AV route for modifying the ETA.

According to still another mode of the present disclosure, the controlling includes modifying the at least one FPD process for execution.

According to another mode of the present disclosure, the controlling includes modifying the at least one scheduled instruction.

According to yet another mode of the present disclosure, the method further includes obtaining, from a user preference lookup table (LUT), user preference data for a user of the AV, wherein the route is generated in view of the user preference data.

According to still another mode of the present disclosure, the user preference data includes, at least one of: a tolerance in delivery times, a preference of routes or types of routes, a speed range, and a toll road preference.

According to still another mode of the present disclosure, the method further includes obtaining, from an external database server, other vehicle information of other vehicles present in the generated route, in which the estimated time of arrival is determined based on the other vehicle information.

According to still another mode of the present disclosure, the order preparation time is determined based on the ETA, such that the at least one FPD process is executed at a specific time in view of the ETA and not based on when the order was received.

According to still another mode of the present disclosure, the method further includes obtaining, from a restaurant preference lookup table (LUT), a set of restaurant preferences for the restaurant, in which the order preparation time is calculated based on the set of restaurant preferences.

According to still another mode of the present disclosure, the vehicle data further includes: a direction that the AV will take towards the restaurant, an end destination of the route, and potential delays to the ETA.

According to still another mode of the present disclosure, the route specifies a specific area of the restaurant for receiving a complete order.

According to another mode of the present disclosure, a non-transitory computer readable storage medium that stores a computer program, the computer program, when executed by a processor, causing a computer to perform a set of operations. The operations includes receiving, on a user interface of the AV, an order submitted to a restaurant system of a restaurant; obtaining initial vehicle data of the AV based on a location of the restaurant, the initial vehicle data including estimated time of arrival (ETA) at the restaurant; transmitting, to the restaurant system, order data of the order and the initial vehicle data; extracting, from a memory of the restaurant system, at least one food preparation/delivery (FPD) template corresponding to the order data; generating, using a processor of the restaurant system, at least one FPD process for execution by at least one resource of the restaurant system based on the order data and the extracted at least one FPD template; generating, by the restaurant system, at least one scheduled instruction to the at least one resource of the restaurant for executing the at least one FPD process; determining, based on progress status of the at least one FPD process being executed, an estimated order completion time for the order; and controlling the AV and the restaurant system to minimize a difference between the ETA and the estimated order completion time.

According to yet another mode of the present disclosure, a computer for preparing an order received from an autonomous vehicle (AV) is provided. The computer includes a memory that stores instructions, and a processor that executes the instructions, in which, when executed by the processor, the instructions cause the processor to perform a set of operations. The set of operations includes receiving, from the AV, order data of the order submitted to a restaurant system of a restaurant; receiving initial vehicle data of the AV, the initial vehicle data being based on a location of the restaurant and the initial vehicle data including estimated time of arrival (ETA) of the AV at the restaurant; extracting at least one food preparation/delivery (FPD) template corresponding to the order data; generating at least one FPD process for execution by at least one resource of the restaurant system based on the order data and the extracted at least one FPD template; generating at least one scheduled instruction to the at least one resource of the restaurant for executing the at least one FPD process; determining, based on progress status of the at least one FPD process being executed, an estimated order completion time for the order; and controlling the AV and the restaurant system to minimize a difference between the ETA and the estimated order completion time.

According to the other aspect of the present disclosure, a server is further provided that mediates a communication between the restaurant system and the AV. The AV generates a route to a destination. The AV controls an autonomous drive of the AV to the destination based on the route to the destination. The AV receives information indicating a guide route to a facility that satisfies a demand that relates to an order of a user and is sent from the server in response to an operation of the user for inputting the demand. And the AV generates a new route to the destination by merging the guide route with the route to the destination in response to an operation of the user for approving the facility.

According to another mode of the present disclosure, the AV recognizes a surrounding environment including a position of the AV based on detection outputs of plural respective sensors provided in the AV. And the AV generates a new route to the destination according to the surrounding environment.

According to another mode of the present disclosure, the AV sets a guide mode indicating a state that the AV is being guided to the facility when the AV has merged the guide route with the route to the destination.

According to still another mode of the present disclosure, the AV sets the end of the guide mode when arriving at the facility.

According to yet another mode of the present disclosure, when receiving information that indicates a second guide route, different from the current route, to the facility and is sent from the server, the AV generates a new route to the destination by merging the second guide route with the route to the destination.

According to another mode of the present disclosure, when receiving information that indicates a third guide route to another facility and is sent from the server in the guide mode, the AV generates a new route to the destination by merging the third guide route with the route to the destination in response to an operation of the user for approving the other facility.

According to still another mode of the present disclosure, the AV generates a new route to the destination according to the surrounding environment in a guide mode indicating a state that the AV is being guided to the facility after merging the guide route with the route to the destination.

According to yet another mode of the present disclosure, the server judges presence/absence of kickback corresponding to the details of the order after completion of settlement processing for the order of the user of the AV in the restaurant system. And if judging that the details of the order are eligible for kickback, the server sends a request for kickback processing to the restaurant system.

According to a further mode of the present disclosure, the server receives a result of the kickback processing performed by the restaurant system in response to the request for kickback processing.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A synchronization system for synchronizing operations of an autonomous vehicle (AV) and a restaurant system of a restaurant,
wherein the AV
receives, by a user interface of the AV, an order submitted to the restaurant system;
obtains initial vehicle data of the AV based on a location of the restaurant, the initial vehicle data including an estimated time of arrival (ETA) at the restaurant; and
transmits, to the restaurant system, order data of the order and the initial vehicle data;
wherein the restaurant system
extracts, from a memory of the restaurant system, at least one food preparation/delivery (FPD) template corresponding to the order data;
generates, using a processor of the restaurant system, at least one FPD process for execution by at least one resource of the restaurant based on the order data and the extracted at least one FPD template;
generates at least one scheduled instruction to the at least one resource of the restaurant for executing the at least one FPD process by the restaurant system; and
determines, based on a progress status of the at least one FPD process being executed, an estimated order completion time for the order; and
wherein the synchronization system controls the AV and the restaurant system to minimize a difference between the ETA and the estimated order completion time.

2. The synchronization system of claim 1,
wherein the restaurant system
monitors a progress status of the at least one FPD process;
determines whether a revision of the at least one FPD process is warranted based on the progress status of the at least one FPD process; and
when the revision of the at least one FPD process is determined to be warranted, revises the schedule instruction based on the revised at least one FPD process.

3. The synchronization system of claim 2, wherein the restaurant system determines whether a revision of the at least one FPD process is warranted at predetermined intervals.

4. The synchronization system of claim 2, wherein the restaurant system determines whether a revision of the at least one FPD process is warranted when an event is detected.

5. The synchronization system of claim 1,
wherein the restaurant system
extracts a preference of the restaurant from the memory; and
generates the at least one scheduled instruction in accordance with the restaurant preference.

6. The synchronization system of claim 1,
wherein the AV
generates updated vehicle data of the AV; and
transmits the updated vehicle data of the AV to the restaurant system.

7. The synchronization system of claim 6, wherein the AV generates updated vehicle data at predetermined intervals.

8. The synchronization system of claim 6, wherein the AV generates updated vehicle data in response to detection of an incident.

9. The synchronization system of claim 1, wherein the restaurant system has a route of the AV modified to modify the ETA, as a control of the restaurant system.

10. The synchronization system of claim 1, wherein the restaurant system modifies the at least one FPD process for execution as a control of the restaurant system.

11. The synchronization system of claim 1, wherein the restaurant system modifies the at least one scheduled instruction as a control of the restaurant system.

12. The synchronization system of claim 1,
wherein the AV
obtains, from a user preference lookup table (LUT) provided therein, preference data for a user of the AV; and
generates a route of the AV in view of the user preference data.

13. The synchronization system of claim 12, wherein the user preference data includes at least one of:
a tolerance in delivery time,
a preference of routes or types of routes,
a speed range, and
a toll road preference.

14. The synchronization system of claim 1,
wherein the AV
obtains, from an external database server, other vehicle information of other vehicles present in the generated route; and
determines the ETA based on the other vehicle information.

15. The synchronization system of claim 1, wherein the restaurant system determines the order preparation time based on the ETA rather than a time of reception of the order so that the at least one FPD process is executed at a specific time before the ETA.

16. The synchronization system of claim 1,
wherein the restaurant system
obtains, from a restaurant preference lookup table (LUT) provided therein, a set of preferences for the restaurant; and
calculates a preparation time for the order based on the set of restaurant preferences.

17. The synchronization system of claim 1, wherein the vehicle data further includes:
a direction that the AV will take towards the restaurant,
an end destination of the route, and
potential delays to the ETA.

18. The synchronization system of claim 1, wherein the route specifies a specific area of the restaurant for receiving a complete order.

19. A synchronization method for synchronizing operations of an autonomous vehicle (AV) and a restaurant system of a restaurant, the method comprising:
receiving, by a user interface of the AV, an order submitted to the restaurant system;
obtaining initial vehicle data of the AV based on a location of the restaurant, the initial vehicle data including estimated time of arrival (ETA) at the restaurant; and
transmitting, to the restaurant system, order data of the order and the initial vehicle data;
extracting, from a memory of the restaurant system, at least one food preparation/delivery (FPD) template corresponding to the order data;
generating, using a processor of the restaurant system, at least one FPD process for execution by at least one resource of the restaurant based on the order data and the extracted at least one FPD template;
generating at least one scheduled instruction to the at least one resource of the restaurant for executing the at least one FPD process by the restaurant system;
determining, based on a progress status of the at least one FPD process being executed, an estimated order completion time for the order; and
controlling the AV and the restaurant system to minimize a difference between the ETA and the estimated order completion time.

20. A non-transitory computer readable storage medium that is stored with a computer program that, when run by a processor, causes a computer to execute a process comprising:
receiving, by a user interface of the AV, an order submitted to a restaurant system of a restaurant;
obtaining initial vehicle data of the AV based on a location of the restaurant, the initial vehicle data including estimated time of arrival (ETA) at the restaurant;
transmitting, to the restaurant system, order data of the order and the initial vehicle data;
extracting, from a memory of the restaurant system, at least one food preparation/delivery (FPD) template corresponding to the order data;
generating, using a processor of the restaurant system, at least one FPD process for execution by at least one resource of the restaurant based on the order data and the extracted at least one FPD template;
generating at least one scheduled instruction to the at least one resource of the restaurant for executing the at least one FPD process by the restaurant system;
determining, based on progress status of the at least one FPD process being executed, an estimated order completion time for the order; and
controlling the AV and the restaurant system to minimize a difference between the ETA and the estimated order completion time.

21. A computer apparatus for preparing an order received from an autonomous vehicle (AV), the computer apparatus comprising:
a memory that stores instructions, and
a processor that executes the instructions,
wherein, when executed by the processor, the instructions cause the processor to perform operations comprising:
receiving, from the AV, order data of an order submitted to a restaurant system of a restaurant;
receiving initial vehicle data of the AV, the initial vehicle data being based on a location of the restaurant and including an estimated time of arrival (ETA) of the AV at the restaurant;
extracting at least one food preparation/delivery (FPD) template corresponding to the order data;
generating at least one FPD process for execution by at least one resource of the restaurant based on the order data and the extracted at least one FPD template;
generating at least one scheduled instruction to the at least one resource of the restaurant for executing the at least one FPD process;
determining an estimated order completion time for the order based on a progress status of the at least one FPD process being executed; and
controlling the AV and the restaurant system to minimize a difference between the ETA and the estimated order completion time.

22. The synchronization system of claim 1, further comprising a server that mediates a communication between the restaurant system and the AV,
wherein the AV
generates a route to a destination;
controls an autonomous drive of the AV to the destination based on the route to the destination;
receives information indicating a guide route to a facility that satisfies a demand relating to an order of a user and is sent from the server in response to an operation of the user for inputting the demand; and
generates a new route to the destination by merging the guide route with the route to the destination in response to an operation of the user for approving the facility.

23. The synchronization system of claim 22,
wherein the AV
recognizes a surrounding environment including a position of the AV based on detection outputs of plural respective sensors provided in the AV; and
generates the new route to the destination according to the surrounding environment.

24. The synchronization system of claim 22, wherein the AV sets a guide mode indicating a state that the AV is being guided to the facility when the AV has merged the guide route with the route to the destination.

25. The synchronization system of claim 24, wherein the AV sets the end of the guide mode when arriving at the facility.

26. The synchronization system of claim 24, wherein when receiving information that indicates a second guide route, different from the current route, to the facility and is sent from the server, the AV generates a new route to the destination by merging the second guide route with the route to the destination.

27. The synchronization system of claim 24, wherein when receiving information that indicates a third guide route to another facility and is sent from the server in the guide mode, the AV generates a new route to the destination by merging the third guide route with the route to the destination in response to an operation of the user for approving the other facility.

28. The synchronization system of claim 23, wherein the AV generates a new route to the destination according to the surrounding environment in a guide mode indicating a state that the AV is being guided to the facility after merging the guide route with the route to the destination.

29. The synchronization system of claim 22,
wherein the server
judges presence or absence of kickback processing corresponding to the details of the order after completion of settlement processing for the order of the user of the AV in the restaurant system; and
if judging that the details of the order are eligible for the kickback processing, sends a request for the kickback processing to the restaurant system.

30. The synchronization system of claim 29, wherein the server receives a result of the kickback processing performed by the restaurant system in response to the request for the kickback processing.
